(19) United States
(12) Patent Application Publication
(10) Pub. No.: US 2012/0252714 A1
(43) Pub. Date: Oct. 4, 2012

(54) Liquid Cleaning Compositions Containing Sulfonated Estolides and Polymeric Foam Builders

(76) Inventors: Randal J. Bernhardt, Antioch, IL (US); Gregory P. Dado, Chicago, IL (US); Dennis S. Murphy, Libertyville, IL (US)

(21) Appl. No.: 13/491,251

(22) Filed: Jun. 7, 2012

Related U.S. Application Data
(63) Continuation of application No. PCT/US2010/059906, filed on Dec. 10, 2010.
(60) Provisional application No. 61/285,826, filed on Dec. 11, 2009.

(51) Int. Cl. C11D 17/00

(52) U.S. Cl. 510/337

(57) ABSTRACT

Liquid cleaning compositions are described that comprise sulfo-estolides (SE) and cationic polymers, wherein the cationic polymers serve to increase the foam volume of the liquid cleaning composition compared to a sulfo-estolide-containing composition that does not contain the cationic polymer. The liquid cleaning compositions can be used in machine and hand-laundering applications where high foam volume is desired.

### RELATED APPLICATIONS

This application is a continuation of International application Serial No. PCT/US2010/059906 (International Publication No. WO 2011/072232), having an International filing date of Dec. 10, 2010, This PCT application claims priority to and benefit from U.S. provisional patent application Ser. No. 61/285,826, filed Dec. 11, 2009. The entire specifications of the PCT and provisional applications referred to above are hereby incorporated by reference.

### BACKGROUND OF THE INVENTION

The present technology relates to compositions comprising sulfo-estolides. Such compositions, in general, are disclosed in U.S. patent application Publication No. 2010/0016198, filed Jul. 21, 2009. More particularly, the present technology relates to liquid cleaning compositions comprising sulfo-estolides and cationic polymers. Sulfo-estolides (SE) have very low foam generation when incorporated into liquid detergents. Such low foam generation is a desirable attribute for liquid detergent compositions intended for front-loading fabric washing machines. In the case of a top-loading fabric washing application, however, low foaming is a drawback since the consumer expects a certain level of foam to be generated as a signal that their fabrics are being cleaned. Attempts to mix SE with co-surfactants that, by themselves, produce foam in order to increase the amount of detergent foaming have not been successful since the overall mix of SE and high foaming surfactants still does not foam well. Thus, there is an ongoing need to afford a sulfo-estolide-containing liquid cleaning composition with significant foam generation when used in liquid cleaning applications where high foaming is desirable, such as, for example, detergent compositions intended for use in top-loading fabric washing machines and hand laundering applications.

### BRIEF SUMMARY OF THE INVENTION

Accordingly, one aspect of the present technology is a liquid cleaning composition that comprises sulfo-estolides and an effective amount of at least one cationic polymer to obtain an increase in foam compared to a sulfo-estolide composition that does not comprise the cationic polymer.

In another aspect, the present technology provides a liquid cleaning composition comprising about 1% to about 50% by weight of at least one compound having the following Formula 1:

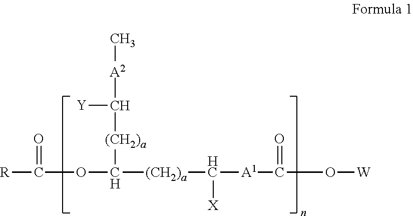

wherein n is an integer from 1-30, one of X and Y is SO₃—Z, the other of X and Y is H, and X and Y are independently assigned in each repeating unit, A¹ and A² are linear or branched, saturated or unsaturated, substituted or un-substituted, alkyl diradicals wherein the total number of carbons for each repeating unit is independent and in the range of C₈ to C₂₂, a is 0, 1, or 2, and is independently assigned in each repeating unit, R is linear or branched, saturated or unsaturated, substituted or un-substituted, wherein the total number of carbon atoms is from about 1 to about 24, W is a monovalent cation, divalent metal cation, ammonium cation, substituted ammonium cation, alkyl group, substituted alkyl group or mixture thereof, Z is a monovalent cation, divalent metal cation, ammonium cation, substituted ammonium cation, or mixture thereof, and an effective amount of a cationic polymeric foam builder, wherein the polymeric foam builder comprises monomer units having a cationic charge at a pH of from about 4 to about 12.

### BRIEF DESCRIPTION OF SEVERAL VIEWS OF THE DRAWINGS

[Not Applicable]

### DETAILED DESCRIPTION OF THE INVENTION

The present technology, in general, relates to sulfo-estolides. More particularly, the present technology relates to liquid cleaning compositions comprising sulfo-estolides derivatives, including salts thereof, and cationic polymers. It has surprisingly been found that, in SE-containing liquid cleaning compositions, cationic-containing polymers boost, or build the level of foam that SE-containing compositions can generate. While not wishing to be bound by theory, it is believed that the boost in foam is the result of increased surface activity afforded by the SE-cationic polymer complex. The boost in foaming is surprising because, although it is known that cationic polymers can enhance foaming or extend foaming in a composition that already exhibits good foaming performance, the effect that such cationic polymers could have on non-foaming or low-foaming compositions, such as sulfo-estolide-containing compositions, could not be predicted. This is especially true in the case of sulfo-estolide-containing compositions because other co-surfactants that are known to be high foaming can not, when mixed with the sulfo-estolide, boost the foaming of the sulfo-estolide composition. The compositions comprising sulfo-estolide and high foaming co-surfactants still exhibit very low foaming levels. Thus, it could not be predicted which, if any, components could be added to a low foaming sulfo-estolide-containing composition to boost the foaming level of the sulfo-estolide composition.

The compositions described herein include, but are not limited to, sulfo-estolides having the structure of general Formula 1:

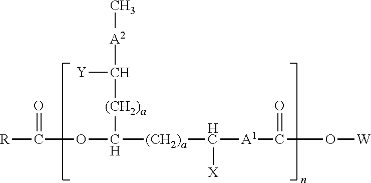

In general Formula 1:

n is an integer from about 1 to about 30, alternatively about 1 to about 10, alternatively 1 to 4, alternatively 1, 2, or 3, alternatively 1 or 2, alternatively 1; or a mixture thereof;

One of X and Y is SO₃⁻Z, the other of X and Y is H (i.e., a hydrogen atom), and X and Y are independently assigned in each repeating unit;

A¹ and A² are independently selected linear or branched, saturated or unsaturated, substituted or unsubstituted alkyl diradicals, where the total number of carbons for each repeating unit is independent and in the range of C₈ to C₂₂. As defined here, the term “alkyl diradical” is meant to refer to a linking hydrocarbon or alkylene segment, for example but by no means limited to —(CH₂)₃—, —(CH₂)₄—, —(CH₂)₅—, and so forth;

a is 0, 1, or 2, and is independently assigned in each repeating unit. When a=0, 1, or 2, the functional group corresponds to an alpha-sulfo-estolide, beta-sulfo-estolide, or gamma-sulfo-estolide, respectively;

R can be linear or branched, saturated or unsaturated, substituted or un-substituted hydrocarbon, wherein the total number of carbon atoms can be from about 1 to about 24. In at least one embodiment, R has from about 7 to about 21 carbon atoms, alternatively from about 8 to about 16 carbon atoms, and can be a saturated or unsaturated linear or branched hydrocarbon, a linear or branched hydroxyalkane sulfonate, or a linear or branched alkene sulfonate. For example, in one embodiment, A¹ and A² are linear alkyl diradicals and R is saturated or unsaturated linear hydrocarbon, linear hydroxyalkane sulfonate, or linear alkene sulfonate having from about 7 to about 21, alternatively from about 8 to about 16 carbons;

W is a monovalent or divalent metal; ammonium; substituted ammonium; H; or a linear or branched, substituted or unsubstituted alkyl having from about 1 to about 22 carbon atoms. For example, W can be an alkali or alkaline earth metal cation. Alternatively, W can be a glycerine joined by an ester linkage, e.g., a substituted C3 alkyl such that the structure of general Formula 1 is incorporated one or more times as an ester in a monoglyceride, a diglyceride, or a triglyceride.

Z is H or a monovalent or divalent metal cation, ammonium or substituted ammonium cation, preferably an alkali or alkaline earth metal cation, for example potassium, sodium, calcium, or magnesium.

### Sulfo-Estolide Component

The term “sulfo-estolide” (“SE”) is used here to describe Formula 1. The term “partially hydrolyzed sulfo-estolide” (“PHSE”) describes compositions of Formula 1 wherein the esters have been partially hydrolyzed between (1% to 95%). The term “hydrolyzed sulfo-estolide” (“HSE”) describes compositions of Formula 1 wherein the esters have been fully hydrolyzed (greater than about 95%, for example).

A suitable starting material for preparing the sulfo-estolide used in the compositions of the present technology is a fatty acid (fatty carboxylic acid). Fatty acids that may be suitable for use in the present technology include but are not limited to linear unsaturated fatty acids of about 8 to about 24 carbons, branched unsaturated fatty acids of about 8 to about 24 carbons, or mixtures thereof. Unsaturated fatty acids provided from commercial sources containing both saturated and unsaturated fatty acids are suitable for use in the present technology. Mixtures of saturated fatty acids and unsaturated fatty acids are also contemplated. In a non-limiting example, fatty acid mixtures that are rich in oleic acid (cis-9-octadecenoic acid) are suitable feedstocks. Other unsaturated fatty acids, for example but not limited to, trans-octadecenoic acids or palmitoleic acid may also be employed in the presently described technology.

Suitable feedstocks may be derived from vegetable and/or animal sources, including but not limited to fatty acids and fatty acid mixtures derived from canola oil, corn oil, cottonseed oil, linseed oil, olive oil, palm oil, peanut oil, rapeseed oil, safflower oil, sesame oil, soybean oil, sunflower oil, tall oil, tung oil, lard, poultry fat, BFT (bleachable fancy tallow), edible tallow, coconut oil, cuphea oil, yellow grease and combinations of these. Also contemplated are genetically modified or engineered oils that include, but are not limited to high oleic sunflower or soybean oil. In some embodiments, the preferred unsaturated fatty acid feedstocks may contain reduced levels of polyunsaturated fatty acids, for example, less than 15%, alternatively less than 10%, alternatively less than 5% on a total weight basis. In some additional embodiments, the fatty acid feedstocks may be obtained by the partial hydrogenation of unsaturated triglycerides, for example soybean oil, followed by hydrolysis of the oil to afford fatty acids that are enriched in monounsaturated fatty acids and depleted in polyunsaturated fatty acids. The above-noted triglycerides optionally hydrogenated, can also be used as feedstocks, alone or in combination with fatty acids. Suitable feedstocks may also include those that contain saturated fatty acids. Further, the feedstocks may be enriched in mono unsaturated fatty acids, for example, via distillation; however, undistilled feedstocks are preferred due to lower cost.

The compounds of general Formula 1 and related compounds (for example, where n=0) can be made, for example, by: a) SO₃ sulfonation of a fatty acid, for example oleic acid; b) neutralization with aqueous caustic to afford a sulfonate salt solution with a pH in the range of about 4 to about 10; and c) hydrolysis of the resulting sultones, maintaining the reaction mixture at a pH of about 4 to about 10. Sulfonation can be carried out, for example, using a falling film SO₃ process or other continuous SO₃ sulfonation processes.

The SE produced from sulfonation can be immediately transferred to a vessel or reactor, for example a continuous neutralizer (“CN”), for the purpose of neutralizing sulfonic acids and at least a portion of the carboxylic acids that are present. Alternatively, aging of the SE sulfonic acid may be provided for the purpose of modifying the composition of the acid, particularly with regard to an increase in the amount of esters wherein X and Y within one or more repeating units, in general Formula 1, are both H. Neutralization of the acids is accomplished by reaction with aqueous base, for example but not limited to aqueous NaOH, KOH, ammonium hydroxide, and metal carbonates. In some embodiments, the amount of alkali that may be used in the neutralization is an amount that provides a neutralized product with a pH of about 4 to about 10. In these embodiments, the neutralized reaction mass may be produced in a way that minimizes the hydrolysis of carboxylic esters. In at least some of these embodiments, the amount of carboxylic ester hydrolysis that may occur may approach zero. When utilized, the CN may be operated with a mass fraction of acid of from about 0.1 to about 0.8, optionally about 0.5. The process can be carried out at a temperature of about 20 to about 100° C., alternatively about 40° C. to about 70° C. The free alkalinity level, as measured by titration with aqueous HCl to a bromophenol blue endpoint, optionally using potash (potassium hydroxide) as the caustic, can be from 0 to about 3.5 wt. %, optionally about 2.5 wt. %. Note that all percentages are by weight in this specification, unless otherwise indicated. In a non-limiting example, the final average additions to the CN can be approximately 50% SE sulfonic acid, 35% water, and 15% caustic (50% concentration).

### Hydrolysis of Sultones

The neutralized SE product can be subjected to a hydrolysis step for the purpose of hydrolyzing sultones, sulfonic acid esters, and acid anhydrides. This sultone hydrolysis step may be conducted under conditions that prevent significant sultone hydrolysis of carboxylic esters in the product. The temperature of the sultone hydrolysis reaction mixture may be from about 20° C. to about 140° C., alternatively from about 50° C. to about 90° C. In some embodiments, the pH of the reaction mixture may be maintained in the range of about 4 to about 10 throughout the course of reaction without the need to add additional caustic. In some additional embodiments, additional caustic may be added to ensure that the pH is maintained in the range of about 4 to about 10. The sultone hydrolysis may be conducted in a continuous or batch process method and may be conducted for an amount of time necessary to result in a stabilized level of free alkalinity, as may be judged, for example, by titration to bromophenol blue endpoint with aqueous HCl.

It is contemplated that hydrolysis of sultones may be conducted at a pH above about 10 without substantial carboxylic ester hydrolysis provided that the reaction temperature and free caustic are maintained sufficiently low.

The resulting sultone hydrolyzed product is a salt of sulfo-estolides that can be used to formulate the liquid cleaning compositions of the present technology.

The sulfo-estolide component is present in the liquid cleaning composition in an amount of about 1% to about 99% by weight of the composition, alternatively about 1% to about 50% by weight of the composition.

### Cationic Polymers

In addition to the sulfo-estolides, the present compositions also comprise one or more cationic polymers. Cationic polymers include polymers in which one or more of the constituent monomers are selected from the list of copolymerizable cationic or amphoteric monomers. These monomer units contain a positive charge over at least a portion of the pH range 4-14. A partial listing of monomers can be found in the “International Cosmetic Ingredient Dictionary,” 5th Edition, edited by J. A. Wenninger and G. N. McEwen, The Cosmetic, Toiletry, and Fragrance Association, Washington D.C., 1993. Another source of such monomers can be found in “Encyclopedia of Polymers and Thickeners for Cosmetics”, by R. Y. Lochhead and W. R. Fron, Cosmetics & Toiletries, Vol. 108, May 1993, pp 95-135. Preferred cationic polymers include polyquaternium-2, polyquaternium-7, and polyquaternium-10.

Specifically, monomers useful in the present technology may be represented structurally as etiologically unsaturated compounds as in formula I.

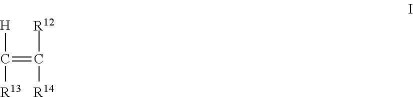

wherein R¹² is hydrogen, hydroxyl, methoxy, or a C₁ to C₃₀ straight or branched alkyl radical; R¹³ is hydrogen, or a C₁₋₃₀ straight or branched alkyl, a C₁₋₃₀ straight or branched alkyl substituted aryl, aryl substituted C₁₋₃₀ straight or branched alkyl radical, or a poly oxyalkene condensate of an aliphatic radical; and R¹⁴ is a heteroatomic alkyl or aromatic radical containing either one or more quaternerized nitrogen atoms or one or more amine groups which possess a positive charge over a portion of the pH interval pH 4 to 12. Such amine groups can be further delineated as having a pKₐ of about 6 or greater.

Examples of cationic monomers of formula I include, but are not limited to, co-poly 2-vinyl pyridine and its co-poly 2-vinyl N-alkyl quaternary pyridinium salt derivatives; co-poly 4-vinyl pyridine and its co-poly 4-vinyl N-alkyl quaternary pyridinium salt derivatives; co-poly 4-vinylbenzyltrialkylammonium salts such as co-poly 4-vinylbenzyltrimethylammonium salt; co-poly 2-vinyl piperidine and co-poly 2-vinyl piperidinium salt; co-poly 4-vinylpiperidine and co-poly 4-vinyl piperidinium salt; co-poly 3-alkyl 1-vinyl imidazolium salts such as co-poly 3-methyl 1-vinyl imidazolium salt; acrylamido and methacrylamido derivatives such as co-poly dimethyl aminopropylmethacrylamide, co-poly acrylamidopropyl trimethylammonium salt and co-poly methacrylamidopropyl trimethylammonium salt; acrylate and methacrylate derivatives such as co-poly dimethyl aminoethyl (meth)acrylate, co-poly ethanaminium N,N,N trimethyl 2-[(1-oxo-2 propenyl)oxy]-salt, co-poly ethanaminium N,N,N trimethyl 2-[(2 methyl-1-oxo-2 propenyl)oxy]-salt, and co-poly ethanaminium N,N,N ethyl dimethyl 2-[(2 methyl-1-oxo-2 propenyl)oxy]-salt.

Also included among the cationic monomers suitable for the present technology are co-poly vinyl amine and co-polyvinylammonium salt; co-poly diallylamine, co-poly methyldiallylamine, and co-poly diallydimethylammonium salt; and the ionene class of internal cationic monomers. This class includes co-poly ethylene imine, co-poly ethoxylated ethylene imine and co-poly quaternized ethoxylated ethylene imine; co-poly [(dimethylimino)trimethylene(dimethylimino)hexamethylene disalt], co-poly [(diethylimino)trimethylene(dimethylimino)trimethylene disalt]; co-poly [(dimethylimino)2-hydroxypropyl salt]; co-polyquarternium-2, co-polyquarternium-17, and co-polyquarternium 18, as defined in the “International Cosmetic Ingredient Dictionary” edited by Wenninger and McEwen.

Additionally, useful polymers are the cationic co-poly amido-amine having the chemical structure of Formula II.

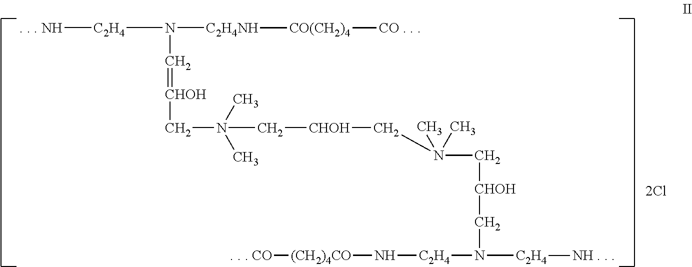

and the quaternized polyimidazoline having the chemical structure of formula III

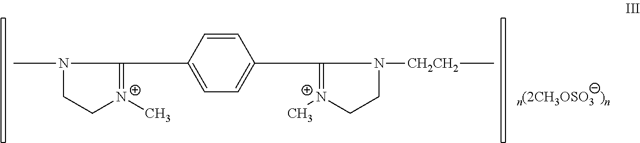

wherein the molecular weight of structures II and III can vary between about 10,000 and 10,000,000 Daltons and each is terminated with an appropriate terminating group such as, for example, a methyl group.

An additional class of cationic monomers suitable for use in the present technology are those arising from natural sources and include, but are not limited to, cocodimethylammonium hydroxypropyl oxyethyl cellulose, lauryldimethylammonium hydroxypropyl oxyethyl cellulose, stearyldimethylammonium hydroxypropyl oxyethyl cellulose, and stearyldimethylammonium hydroxyethyl cellulose; guar 2-hydroxy-3-(trimethylammonium)propyl ether salt; cellulose 2-hydroxyethyl 2-hydroxy 3-(trimethyl ammonio)propyl ether salt.

It is likewise envisioned that monomers containing cationic sulfonium salts such as co-poly 1-[3-methyl-4-(vinyl-benzyloxy)phenyl]tetrahydrothiophenium chloride would also be applicable to the present technology.

The counterion of the cationic co-monomer is selected from: chloride, bromide, iodide hydroxide, phosphate, sulfate, hydrosulfate, ethyl sulfate, methyl sulfate, formate, acetate and mixtures thereof.

Another class of cationic polymer useful for the present invention are the cationic silicones. These materials are characterized by repeating dialkylsiloxane interspersed or end terminated, or both, with cationic substituted siloxane units.

The weight fraction of the cationic polymer which is composed of the above-described cationic monomer units can range from 1 to 100%, preferably from 10 to 100%, and most preferably from 15 to 80% of the entire polymer. The remaining monomer units comprising the cationic polymer are chosen from the class of anionic monomers and the class of nonionic monomers or solely from the class of nonionic monomers. In the former case, the polymer is an amphoteric polymer while in the latter case it can be a cationic polymer, provided that no amphoteric co-monomers are present. Amphoteric polymers should also be considered within the scope of this disclosure, provided that the polymer unit possesses a net positive charge at one or more points over the pH range of pH 4 to 12.

The anionic monomers comprise a class of monounsaturated compounds which possess a negative charge over the portion of the pH range from pH 4 to 12 in which the cationic monomers possess a positive charge. The nonionic monomers comprise a class of monounsaturated compounds which are uncharged over the pH range from pH 4 to 12 in which the cationic monomers possess a positive charge. It is expected that the wash pH at which cleaning compositions of the present technology would be employed would either naturally fall within the above mentioned portion of the pH range 4-12 or, optionally, would be buffered in that range. A preferred class of both the anionic and the nonionic monomers are the vinyl (ethylenically unsaturated) substituted compounds corresponding to formula IV.

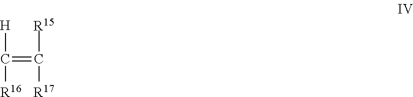

wherein R¹⁵, R¹⁶, and R¹⁷ are independently hydrogen, a C₁ to C₃ alkyl, a carboxylate group or a carboxylate group substituted with a C₁ to C₃₀ linear or branched heteroatomic alkyl or aromatic radical, a heteroatomic radical or a poly oxyalkene condensate of an aliphatic radical.

The class of anionic monomers are represented by the compound described by formula IV in which at least one of the R¹⁵, R¹⁶, or R¹⁷ comprises a carboxylate, substituted carboxylate, phosphonate, substituted phosphonate, sulfate, substituted sulfate, sulfonate, or substituted sulfonate group. Preferred monomers in this class include but are not limited to ethacrylic acid, cyano acrylic acid, dimethacrylic acid, methylenemalonic acid, vinylacetic acid, allylacetic acid, acrylic acid, ethylidineacetic acid, propylidineacetic acid, crotonic acid, methacrylic acid, maleic acid, fumaric acid, itaconic acid, sorbic acid, angelic acid, cinnamic acid, styryl acrylic acid (1-carboxy-4-phenyl butadiene-1,3), citraconic acid, glutaconic acid, aconitic acid, phenylacrylic acid, acryloxy propionic acid, vinyl benzoic acid, N-vinyl succinamidic acid, and mesaconic acid. Also included in the list of preferred monomers are co-poly styrene sulfonic acid, 2-methacryloyloxymethane-1-sulfonic acid, 3-methacryloyloxypropane-1-sulfonic acid, 3-(vinyloxy)propane-1-sulfonic acid, ethylenesulfonic acid, vinyl sulfuric acid, 4-vinylphenyl sulfuric acid, ethylene phosphonic acid and vinyl phosphoric acid. Most preferred monomers include acrylic acid, methacrylic acid and maleic acid. The polymers useful in the present technology may contain the above monomers and the alkali metal, alkaline earth metal, and ammonium salts thereof.

The class of nonionic monomers is represented by the compounds of formula IV in which none of the R¹⁵, R¹⁶, or R¹⁷ contain the above mentioned negative charge containing radicals. Preferred monomers in this class include, but are not limited to, vinyl alcohol; vinyl acetate; vinyl methyl ether; vinyl ethyl ether; acrylamide, methacrylamide and other modified acrylamides; vinyl propionate; alkyl acrylates (esters of acrylic or methacrylic acid); and hydroxyalkyl acrylate esters. A second class of nonionic monomers include co-poly ethylene oxide, co-poly propylene oxide, and co-poly oxymethylene. A third, and highly preferred, class of nonionic monomers includes naturally derived materials such as hydroxyethylcellulose and guar gum.

Additional cationic polymers that can be used to build foam in the liquid cleaning compositions of the present technology are described in detail in U.S. Pat. Nos. 6,656,900; 6,528,477; 7,241,729 and 6,645,925, and include polymeric suds stabilizers present as the free base or as a salt which contain units capable of having a cationic charge at a pH of from about 4 to about 12; quaternary nitrogen-containing monomeric units alone or in combination with other cationic monomeric units, plus one or more nonionic monomeric units; methyl chloride quats of dimethylethyl(meth)acrylates; 2-dimethylaminoethyl methacrylate; methyl chloride quats of dimethylaminopropyl (meth)acrylamides; dimethyl- and diethylsulfate quats of dimethylaminoethyl(meth)acrylates; dimethyl- and diethyl-sulfate quats of dimethylaminopropyl(meth)acrylamides; and diallydimethylammonium halides, such as bromide and/or chloride salts.

The cationic polymer (or polymers) is incorporated into the sulfo-estolide-containing liquid cleaning composition in an effective amount to boost foaming of the composition. By “effective amount” is meant an amount of the cationic polymer that will achieve a level of foaming that is greater than that achieved by a sulfo-estolide-containing composition that does not contain the cationic polymer. In general, an effective amount of the cationic polymer is from about 0.01% to about 10% by weight of the composition, alternatively about 0.05% to about 5%, alternatively about 0.1% to about 2% by weight of the composition. For purposes of the present technology, it is preferred that the cationic polymer have an average cationic charge density from about 0.05 to about 5 units per 100 Daltons molecular weight at a pH of from about 4 to about 12.

### Detergent Compositions

A wide variety of detergent compositions can be made that include SE, PHSE, HSE, SHP, PEHP, EHP, or combinations of two or all of these, as described in the present application, in combination with the cationic polymers, and with or without other ingredients as specified below. Formulations are contemplated comprising 1% to 99% SE, PHSE, HSE, SHP, PEHP, and/or EHP, more preferably between 1% and 50%, even more preferably between 1% and 30%, and 0.01% to about 10% by weight cationic polymers, more preferably from about 0.05% to about 5%, even more preferably from about 0.1% to about 2%, with 99% to 1% water and, optionally, other ingredients as described here.

### Surfactants

The detergent compositions can contain co-surfactants, which can be anionic, cationic, nonionic, ampholytic, zwitterionic, or combinations of these.

### Anionic Surfactants

Although it is preferred that SHP be the only anionic surfactant used in the formulation, other anionic surfactants can be added. “Anionic surfactants” are defined here as amphiphilic molecules with an average molecular weight of less than about 10,000, comprising one or more functional groups that exhibit a net anionic charge when in aqueous solution at the normal wash pH, which can be a pH between 6 and 11. The anionic surfactant used in the present technology can be any anionic surfactant that is substantially water soluble. “Water soluble” surfactants are, unless otherwise noted, here defined to include surfactants which are soluble or dispersible to at least the extent of 0.01% by weight in distilled water at 25° C. It is preferred that at least one of the anionic surfactants used in the present technology be an alkali or alkaline earth metal salt of a natural or synthetic fatty acid containing between about 4 and about 30 carbon atoms. It is especially preferred to use a mixture of carboxylic acid salts with one or more other anionic surfactants. Another important class of anionic compounds is the water soluble salts, particularly the alkali metal salts, of organic sulfur reaction products having in their molecular structure an alkyl radical containing from about 6 to about 24 carbon atoms and a radical selected from the group consisting of sulfonic and sulfuric acid ester radicals.

Specific types of anionic surfactants are identified in the following paragraphs. At least in some embodiments, alkyl ether sulfates are preferred. A less preferred anionic surfactant is linear alkyl benzene sulfonate due to its lower solubility.

Carboxylic acid salts are represented by the formula:

R¹COOM

where R¹ is a primary or secondary alkyl group of 4 to 30 carbon atoms and M is a solubilizing cation. The alkyl group represented by R¹ may represent a mixture of chain lengths and may be saturated or unsaturated, although it is preferred that at least two thirds of the R¹ groups have a chain length of between 8 and 18 carbon atoms. Non-limiting examples of suitable alkyl group sources include the fatty acids derived from coconut oil, tallow, tall oil and palm kernel oil. For the purposes of minimizing odor, however, it is often desirable to use primarily saturated carboxylic acids. Such materials are well known to those skilled in the art, and are available from many commercial sources, such as Uniqema (Wilmington, Del.). and Twin Rivers Technologies (Quincy, Mass.). The solubilizing cation, M, may be any cation that confers water solubility to the product, although monovalent such moieties are generally preferred. Examples of acceptable solubilizing cations for use with the present technology include alkali metals such as sodium and potassium, which are particularly preferred, and amines such as triethanolammonium, ammonium and morpholinium. Although, when used, the majority of the fatty acid should be incorporated into the formulation in neutralized salt form, it is often preferable to leave a small amount of free fatty acid in the formulation, as this can aid in the maintenance of product viscosity.

Primary alkyl sulfates are represented by the formula:

R²OSO₃M

where R² is a primary alkyl group of 8 to 18 carbon atoms. M is H or a cation, e.g., an alkali metal cation (e.g. sodium, potassium, lithium), or ammonium or substituted ammonium (e.g., methyl-, dimethyl-, and trimethyl ammonium cations and quaternary ammonium cations such as tetramethyl-ammonium and dimethyl piperidinium cations and quaternary ammonium cations derived from alkylamines such as ethylamine, diethylamine, triethylamine, and mixtures thereof, and the like). The alkyl group R² may have a mixture of chain lengths. It is preferred that at least two-thirds of the R² alkyl groups have a chain length of 8 to 14 carbon atoms. This will be the case if R² is coconut alkyl, for example. The solubilizing cation may be a range of cations which are in general monovalent and confer water solubility. An alkali metal, notably sodium, is especially envisaged. Other possibilities are ammonium and substituted ammonium ions, such as trialkanolammonium or trialkylammonium.

Alkyl ether sulfates are represented by the formula:

R³O(CH₂CH₂O)ₙSO₃M

where R³ is a primary alkyl group of 8 to 18 carbon atoms, n has an average value in the range from 1 to 6 and M is a solubilizing cation. The alkyl group R³ may have a mixture of chain lengths. It is preferred that at least two-thirds of the R³ alkyl groups have a chain length of 8 to 14 carbon atoms. This will be the case if R³ is coconut alkyl, for example. Preferably n has an average value of 2 to 5. Ether sulfates have been found to provide viscosity build in certain of the formulations of the present technology, and thus are considered a preferred ingredient.

Other suitable anionic surfactants that can be used are alkyl ester sulfonate surfactants including linear esters of C₈-C₂₀ carboxylic acids (i.e., fatty acids) which are sulfonated with gaseous SO₃ according to “The Journal of the American Oil Chemists Society,” 52 (1975), pp. 323-329. Suitable starting materials would include natural fatty substances as derived from tallow, palm oil, etc.

The preferred alkyl ester sulfonate surfactants, especially for laundry applications, comprise alkyl ester sulfonate surfactants of the structural formula:

R³—CH(SO₃M)-C(O)—OR⁴

where R³ is a C₈-C₂₀ hydrocarbyl, preferably an alkyl or combination thereof R⁴ is a C₁-C₆ hydrocarbyl, preferably an alkyl, or combination thereof, and M is a cation which forms a water soluble salt with the alkyl ester sulfonate. Suitable salt-forming cations include metals such as sodium, potassium, and lithium, and substituted or unsubstituted ammonium cations, such as monoethanolamine, diethanolamine, and triethanolamine Preferably, R³ is C₁₀-C₁₆ alkyl, and R⁴ is methyl, ethyl or isopropyl. Especially preferred are the methyl ester sulfonates where R³ is C₁₀-C₁₆ alkyl.

Fatty acid ester sulfonates are represented by the formula:

R⁴CH(SO₃M)CO₂R⁵

where R⁴ is an alkyl group of 6 to 16 atoms, R⁵ is an alkyl group of 1 to 4 carbon atoms and M is a solubilizing cation. The group R⁴ may have a mixture of chain lengths. Preferably at least two-thirds of these groups have 6 to 12 carbon atoms. This will be the case when the moiety R⁴CH(−)CO₂(−) is derived from a coconut source, for instance. It is preferred that R⁵ is a straight chain alkyl, notably methyl or ethyl.

Alkyl benzene sulfonates are represented by the formula:

R⁶ArSO₃M

where R⁶ is an alkyl group of 8 to 18 carbon atoms, Ar is a benzene ring (—C₆H₄—) and M is a solubilizing cation. The group R⁶ may be a mixture of chain lengths. A mixture of isomers is typically used, and a number of different grades, such as “high 2-phenyl” and “low 2-phenyl” are commercially available for use depending on formulation needs. A plentitude of commercial suppliers exist for these materials, including Stepan (Northfield, Ill.) and Witco (Greenwich, CNC). Typically they are produced by the sulfonation of alkylbenzenes, which can be produced by either the HF-catalyzed alkylation of benzene with olefins or an AlCl₃-catalyzed process that alkylates benzene with chloroparaffins, and are sold by, for example, Petresa (Chicago, Ill.) and Sasol (Austin, Tex.). Straight chains of 11 to 14 carbon atoms are usually preferred.

Paraffin sulfonates having about 8 to about 22 carbon atoms, preferably about 12 to about 16 carbon atoms, in the alkyl moiety, are contemplated for use here. They are usually produced by the sulfoxidation of petrochemically-derived normal paraffins. These surfactants are commercially available as, for example, Hostapur SAS from Clariant (Charlotte, N.C.).

Olefin sulfonates having 8 to 22 carbon atoms, preferably 12 to 16 carbon atoms, are also contemplated for use in the present compositions. The olefin sulfonates are further characterized as having from 0 to 1 ethylenic double bonds; from 1 to 2 sulfonate moieties, of which one is a terminal group and the other is not; and 0 to 1 secondary hydroxyl moieties.

Sulfosuccinate esters represented by the formula:

R⁷OOCCH₂CH(SO₃⁻M⁺)COOR⁸

are also useful in the context of the present technology. R⁷ and R⁸ are alkyl groups with chain lengths of between 2 and 16 carbons, and may be linear or branched, saturated or unsaturated. A preferred sulfosuccinate is sodium bis(2-ethylhexyl) sulfosuccinate, which is commercially available under the trade name Aerosol OT from Cytec Industries (West Paterson, N.J.).

Organic phosphate based anionic surfactants include organic phosphate esters such as complex mono- or diester phosphates of hydroxyl-terminated alkoxide condensates, or salts thereof. Included in the organic phosphate esters are phosphate ester derivatives of polyoxyalkylated alkylaryl phosphate esters, of ethoxylated linear alcohols and ethoxylates of phenol. Also included are nonionic alkoxylates having a sodium alkylenecarboxylate moiety linked to a terminal hydroxyl group of the nonionic through an ether bond. Counterions to the salts of all the foregoing may be those of alkali metal, alkaline earth metal, ammonium, alkanolammonium and alkylammonium types.

Fatty acid ester sulfonates are represented by the formula:

R⁹CH(SO₃M)CO₂R¹⁰

where the moiety R⁹CH(−)CO₂(−) is derived from a coconut source and R¹⁰ is either methyl or ethyl.

Another class of preferred anionic surfactants contemplated for the present purposes is the alkyl alkoxylated sulfate surfactants which are water soluble salts or acids of the formula RO(A)ₘSO₃M where R is an unsubstituted C₁₀-C₂₄ alkyl or hydroxyalkyl group having a C₁₀-C₂₄ alkyl component, preferably a C₁₂-C₁₈ alkyl or hydroxyalkyl, more preferably C₁₂-C₁₅ alkyl or hydroxyalkyl, A is an ethoxy or propoxy unit, m is greater than zero, typically between about 0.5 and about 6, more preferably between about 0.5 and about 3, and M is H or a cation which can be, for example, a metal cation (e.g., sodium, potassium, lithium, calcium, magnesium, etc.), ammonium or substituted-ammonium cation. Alkyl ethoxylated sulfates as well as alkyl propoxylated sulfates are contemplated here. Specific examples of substituted ammonium cations include ethanol-, triethanol-, methyl-, dimethyl-, or trimethylammonium cations and quaternary ammonium cations such as tetramethyl-ammonium and dimethyl piperidinium cations and those derived from alkylamines such as ethylamine, diethylamine, triethylamine, mixtures thereof and the like. Exemplary surfactants are C₁₂-C₁₅ alkyl polyethoxylate (1.0) sulfate (C₁₂-C₁₅ E(1.0)M), C₁₂-C₁₅ alkyl polyethoxylate (2.25) sulfate (C₁₂-C₁₅ E(2.25)M), C₁₂-C₁₅ alkyl polyethoxylate (3.0) sulfate (C₁₂-C₁₅ E(3.0)M), and C₁₂-C₁₅ alkyl polyethoxylate (4.0) sulfate (C₁₂-C₁₅ E(4.0)M), where M is conveniently selected from sodium and potassium.

Other anionic surfactants useful for detersive purposes can also be included in the detergent compositions of the present technology. These can include salts (including, for example, sodium, potassium, ammonium, and substituted ammonium salts such as mono-, di- and triethanolamine salts) of soap, C₈-C₂₂ primary of secondary alkanesulfonates, C₈-C₂₄ olefin sulfonates, sulfonated polycarboxylic acids prepared by sulfonation of the pyrolyzed product of alkaline earth metal citrates, e.g., as described in British patent specification No. 1,082,179, C₈-C₂₄ alkypolyglycolethersulfates (containing up to 10 moles of ethylene oxide); alkyl glycerol sulfonates, fatty acyl glycerol sulfonates, fatty oleoyl glycerol sulfates, alkyl phenol ethylene oxide ether sulfates, paraffin sulfonates, alkyl phosphates, isethionates such as the acyl isethionates, N-acyl taurates, alkyl succinamates and sulfosuccinates, monoesters of sulfosuccinates (especially saturated and unsaturated C₁₂-C₁₈ monoesters) and diesters of sulfosuccinates (especially saturated and unsaturated C₆-C₁₂ diesters), sulfates of alkylpolysaccharides such as the sulfates of alkylpolyglucoside (the nonionic non-sulfated compounds being described below), and alkyl polyethoxy carboxylates such as those of the formula RO(CH₂CH₂O)ₖCH₂COO-M+ where R is a C₈-C₂₂ alkyl, k is an integer from 0 to 10, and M is a soluble salt-forming cation. Resin acids and hydrogenated resin acids are also suitable, such as rosin, hydrogenated rosin, and resin acids and hydrogenated resin acids present in or derived from tall oil. Further examples are described in “Surface Active Agents and Detergents,” (Vols. I and II by Schwartz, Perry and Berch). A variety of such surfactants are also generally disclosed in U.S. Pat. No. 3,929,678, issued Dec. 30, 1975 to Laughlin, et al. at col. 23, line 58 through col. 29, line 23 including ordinary alkali metal soaps such as the sodium, potassium and ammonium salts of higher fatty acids containing from about 8 to about 24 carbon atoms; water-soluble salts, particularly alkali metal salts; anionic phosphate surfactants; salts of 2-acyloxyalkane-1-sulfonic acids; alkylated α-sulfocarboxylates, containing about 10 to about 23 carbon atoms; β-alkyloxy alkane sulfonates; alkyl ether sulfates; reaction products of fatty acids esterified with isethionic acid and neutralized with sodium hydroxide; di-anionic detergents; succinamates; and olefin sulfonates having about 12 to about 24 carbon atoms. A variety of such surfactants are additionally disclosed in Unilever U.S. Pat. No. 6,949,498 col. 6, line 4 through col. 8, line 30 including, carboxylic acid salts, primary alkyl sulfates, alkyl ether sulfates, fatty acid ester sulfonates, alkyl benzene sulfonates, sulfosuccinate esters, isethionates, sulfated triglycerides, alcohol sulfates, ligninsulfonates, naphthelene sulfonates and alkl naphthalene sulfonates.

Other anionic surfactants contemplated for use with this formulation include isethionates, sulfated triglycerides, alcohol sulfates, ligninsulfonates, naphthelene sulfonates and alkyl naphthelene sulfonates and the like. Additional anionic surfactants, falling into the general definition but not specifically mentioned above, should also be considered within the scope of the present technology.

Specific anionic surfactants contemplated for use in the present compositions include alcohol ether sulfates (AES), linear alkylbenzene sulfonates (LAS), alcohol sulfates (AS), alpha methyl ester sulfonates (MES), or combinations of two or more of these. The amount of anionic surfactant contemplated can be, for example, 1% to 70% of the composition, more preferably between 1% and 60%, even more preferably between 1% and 40%. For a more general description of surfactants, see, P&G U.S. Pat. No. 5,929,022; col. 3, 2nd paragraph through col. 4, end of 1st paragraph.

### Cationic Surfactants

Specific cationic surfactants contemplated for use in the present compositions include ditallow dimethylammonium chloride (DTDMAC), fatty alkanolamides (FAA), and quaternized diesters of trialkanolamines and fatty acids. The proportions of cationic surfactants used in a formulation can range, for example, from 0.1% to 20%, more preferably between 1% and 10%, even more preferably between 1% and 5%. See also, P&G U.S. Pat. No. 5,929,022; col. 6, 2nd paragraph through col. 7, 1st paragraph, from which much of the following discussion comes:

Cationic detersive surfactants suitable for use in the laundry detergent compositions of the present technology include those having one long-chain hydrocarbyl group. Examples of such cationic surfactants include the ammonium surfactants, such as alkyldimethylammonium halogenides, and those surfactants having the formula:

[R²(OR³)_{y}][R⁴(OR³)_{y}]₂R⁵N⁺X⁻

where R² is an alkyl or alkyl benzyl group having from about 8 to about 18 carbon atoms in the alkyl chain, each R³ is selected from the group consisting of —CH₂CH₂—, —CH₂CH(CH₃)—, —CH₂CH(CH₂OH)—, —CH₂CH₂CH₂—, and mixtures thereof; each R⁴ is selected from the group consisting of C₁-C₄ alkyl, C₁-C₄ hydroxyalkyl, benzyl ring structures formed by joining the two R⁴ groups, —CH₂CHOH—CH(OH)C(O)R⁶CH(OH)CH₂OH where R⁶ is any hexose or hexose polymer having a molecular weight less than about 1000, and hydrogen when y is not 0; R⁵ is the same as R⁴ or is an alkyl chain where the total number of carbon atoms of R² plus R⁵ is not more than about 18; each y is from 0 to about 10 and the sum of the y values is from 0 to about 15; and X is any compatible anion. The long chain cationic surfactant can also be the quaternized version of stearamidopropyl dimethylamine (e.g. stearamidopropyl trimethylamine chloride).

Preferred cationic surfactants are the water-soluble quaternary ammonium compounds useful in the present composition having the formula:

R¹R²R³R⁴N⁺X⁻

where R¹ is C₈-C₁₆ alkyl, each of R², R³ and R⁴ is independently C₁-C₄ alkyl, C₁-C₄ hydroxyalkyl, benzyl, or —(C₂H₄O)ₓH where x has a value from 1 to 5, and X is an anion. In an embodiment, not more than one of R², R³ or R⁴ is benzyl.

The preferred alkyl chain length for R¹ is C₁₂-C₁₅, particularly where the alkyl group is a mixture of chain lengths derived from coconut or palm kernel fat or is derived synthetically by olefin build up or OXO alcohols synthesis. Preferred groups for R², R³, and R⁴ are methyl and hydroxyethyl groups and the anion X may be selected from halide, methosulphate, acetate and phosphate ions.

Examples of suitable quaternary ammonium compounds for use here are:
hexadecyl trimethyl ammonium chloride, also known as cetrimonium chloride, sold commercially as Ammonyx® CETAC by Stepan Co.;
coconut trimethyl ammonium chloride or bromide;
coconut methyl dihydroxyethyl ammonium chloride or bromide;
decyl triethyl ammonium chloride;
decyl dimethyl hydroxyethyl ammonium chloride or bromide;
C₁₂₋₁₅ dimethyl hydroxyethyl ammonium chloride or bromide;
coconut dimethyl hydroxyethyl ammonium chloride or bromide;
myristyl trimethyl ammonium methyl sulphate;
lauryl dimethyl benzyl ammonium chloride or bromide;
lauryl dimethyl (ethenoxy)₄ ammonium chloride or bromide;
choline esters of formula

R¹R²R³R⁴N⁺X⁻
where R¹ is —CH₂—O—C(O)—(C₁₂₋₁₄ alkyl) and R², R³, and R⁴ are methyl; and
combinations of these.

Other cationic surfactants useful here are also described in U.S. Pat. No. 4,228,044, Cambre, issued Oct. 14, 1980.

### Nonionic Surfactants

Examples of suitable nonionic surfactants include alkyl polyglucosides (“APGs”), alcohol ethoxylates, nonylphenol ethoxylates, and others. The nonionic surfactant may be used as from 1% to 90%, more preferably from 1 to 40% and most preferably between 1% and 32% of a detergent composition. Other suitable nonionic surfactants are described in P&G U.S. Pat. No. 5,929,022; col. 4, 2nd paragraph through col. 6, end of 1st paragraph, from which much of the following discussion comes:

One class of nonionic surfactants useful in the practice of the present technology are condensates of ethylene oxide with a hydrophobic moiety to provide a surfactant having an average hydrophilic-lipophilic balance (HLB) in the range from 8 to 17, preferably from 9.5 to 14, more preferably from 12 to 14. The hydrophobic (lipophilic) moiety may be aliphatic or aromatic in nature and the length of the polyoxyethylene group which is condensed with any particular hydrophobic group can be readily adjusted to yield a water-soluble compound having the desired degree of balance between hydrophilic and hydrophobic elements.

For “low HLB” nonionics, low HLB can be defined as having an HLB of 8 or less and preferably 6 or less. A “low level” of co-surfactant can be defined as 6% or less of the HDL and preferably 4% or less of the HDL.

Especially preferred nonionic surfactants of this type are the C₉-C₁₅ primary alcohol ethoxylates containing 3-12 moles of ethylene oxide per mole of alcohol, particularly the C₁₂-C₁₅ primary alcohols containing 5-8 moles of ethylene oxide per mole of alcohol. One suitable example of such a surfactant is polyalkoxylated aliphatic base, sold for example as Makon® NF-12 by Stepan Co.

Another class of nonionic surfactants comprises alkyl polyglucoside compounds of general formula

RO—(CₙH₂ₙO)ₜZₓ

where Z is a moiety derived from glucose; R is a saturated hydrophobic alkyl group that contains from 12 to 18 carbon atoms; t is from 0 to 10 and n is 2 or 3; x is an average value from 1.3 to 4, the compounds including less than 10% unreacted fatty alcohol and less than 50% short chain alkyl polyglucosides. Compounds of this type and their use in detergent compositions are disclosed in EP-B 0 070 077, EP 0 075 996 and EP 0 094 118.

Very suitable as nonionic surfactants are poly hydroxy fatty acid amide surfactants of the formula

R²—C(O)—N(R¹)—Z

where R¹ is H, or R¹ is C₁₋₄ hydrocarbyl, 2-hydroxyethyl, 2-hydroxypropyl or a mixture thereof, R² is C₅₋₃₁ hydrocarbyl, and Z is a polyhydroxyhydrocarbyl having a linear hydrocarbyl chain with at least 3 hydroxyls directly connected to the chain, or an alkoxylated derivative thereof. Preferably, R¹ is methyl, R² is a straight C₁₁₋₁₅ alkyl or alkenyl chain such as coconut alkyl or mixtures thereof, and Z is derived from a reducing sugar such as glucose, fructose, maltose, lactose, in a reductive amination reaction.

Highly preferred nonionics are amine oxide surfactants. The compositions of the present technology may comprise amine oxide in accordance with the general formula:

R¹(EO)ₓ(PO)_{y}(BO)_{z}N(O)(CH₂R′)₂.H₂O

In general, it can be seen that the preceding formula provides one long-chain moiety R¹(EO)ₓ(PO)_{y}(BO)_{z} and two short chain moieties, —CH₂R′. R′ is preferably selected from hydrogen, methyl and —CH₂OH. In general R¹ is a primary or branched hydrocarbyl moiety which can be saturated or unsaturated, preferably, R¹ is a primary alkyl moiety. When x+y+z=0, R¹ is a hydrocarbyl moiety having a chain length of from about 8 to about 18. When x+y+z is different from 0, R¹ may be somewhat longer, having a chain length in the range C₁₂-C₂₄. The general formula also encompasses amine oxides where x+y+z=0, R¹ is C₈-C₁₈, R′ is H and q=from 0 to 2, preferably 2. These amine oxides are illustrated by C₁₂₋₁₄ alkyldimethyl amine oxide, hexadecyl dimethylamine oxide, octadcylamine oxide and their hydrates, especially the dihydrates as disclosed in U.S. Pat. Nos. 5,075,501 and 5,071,594, which include N-octyldimethylamine oxide dihydrate, N,N-didecylmethylamine oxide dihydrate, N-decyl-N-dodecylethylamine oxide dihydrate, N-dodecyldimethylamine oxide dihydrate, N-tetradecyldimethylamine oxide dihydrate, N-tetradecyl-N-ethylmethylamine oxide dehydrate, N-tetradecyl-N-ethylmethylamine oxide dehydrate, N-tetradecyl-N-ethyl-2-hydroxyethylamine oxide dihydrate, N,N-di-tetradecyl-2-hydroxyethylamine oxide dihydrate, N-hexadecyl-dimethylamine oxide dihydrate, N-hexadecyldi-2-hydroxyethylamine oxide dihydrate, N-octadecyldimethylamine oxide dihydrate, N,N-dieicosylethylamine oxide dihydrate, N-docosyl-N-2-hydroxyethylmethylamine oxide dehydrate and N-tetracosyldimethylamine oxide dehydrate oxide dihydrate.

The presently described technology also encompasses amine oxides where x+y+z is different from zero, specifically x+y+z is from about 1 to about 10, and R¹ is a primary alkyl group containing about 8 to about 24 carbons, preferably from about 12 to about 16 carbon atoms. In these embodiments y+z is preferably 0 and x is preferably from about 1 to about 6, more preferably from about 2 to about 4; EO represents ethyleneoxy; PO represents propyleneoxy; and BO represents butyleneoxy. Such amine oxides can be prepared by conventional synthetic methods, e.g., by the reaction of alkylethoxysulfates with dimethylamine followed by oxidation of the ethoxylated amine with hydrogen peroxide.

Highly preferred amine oxides here are solids at ambient temperature, more preferably they have melting-points in the range 30° C. to 90° C. Amine oxides suitable for use here are made commercially by a number of suppliers, including Akzo Chemie, Ethyl Corp., and Procter & Gamble. See, McCutcheon's compilation and Kirk-Othmer review article for alternate amine oxide manufacturers. Preferred commercially available amine oxides are the solid, dihydrate ADMOX 16 and ADMOX 18, ADMOX 12 and especially ADMOX 14 from Ethyl Corp.

Preferred embodiments include, for example, hexadecyldimethylamine oxide dihydrate, octa-decyldimethylamine oxide dihydrate, hexadecyltris(ethyleneoxy)dimethylamine oxide, and tetradecyldimethylamine oxide dihydrate.

In certain of the preferred embodiments in which R′ is H, there is some latitude with respect to having R′ slightly larger than H. Specifically, the presently described technology further encompasses embodiments where R′=CH₂OH, such as hexadecylbis(2-hydroxyethyl)amine oxide, tallowbis(2-hydroxyethyl)amine oxide, stearylbis(2-hydroxyethyl)amine oxide and oleylbis(2-hydroxyethyl)amine oxide.

### Ampholytic Surfactants

Ampholytic synthetic detergents can be broadly described as derivatives of aliphatic or aliphatic derivatives of heterocyclic secondary and tertiary amines, in which the aliphatic radical may be straight chain or branched and where one of the aliphatic substituents contains from about 8 to about 18 carbon atoms and at least one contains an anionic water-solubilizing group, e.g., carboxy, sulfo, sulfato, phosphato, or phosphono. Specific examples of ampholytic surfactants are provided in U.S. Pat. No. 3,664,961, col. 6, line 60, to col. 7, line 53, and include sodium 3-(dodecylamino)_propionate, sodium 3-(dodecylamino)propane-1-sulfonate, sodium 2-(dodecylamino)ethyl sulfate, sodium 2)dimethylamino)octadecanoate, disodium 3-(N-carboxymethyl-dodecylamino)propane-1-sulfonate, disodium 3-(N-methyl-hexadecylamino)propyl-1-phosphonate, disodium octadecyl-iminodiacetate, sodium 1-carboxymethyl-2-undecyl-imadazole, disodium 2-[N-(2-hydroxyethyl)octadecylamino]ethyl phosphate and sodium N,N-bis-(2-hydroxyethyl)-2-sulfato-3-dodecoxypropylamine. Examples of suitable ampholytic surfactants include fatty amine oxides and fatty amidopropylamine oxides. A specific suitable example is cocoamidopropyl betaine (CAPB) also known as coco betaine. Ampholytic surfactants can be used at a level from 1% to 50%, more preferably from 1% to 10%, even more preferably between 1% and 5% of the formulation, by weight.

### Zwitterionic Surfactants

Zwitterionic synthetic detergents can be broadly described as derivatives of aliphatic quaternary ammonium and phosphonium or tertiary sulfonium compounds, in which the cationic atom may be part of a heterocyclic ring, and in which the aliphatic radical may be straight chain or branched, and where one of the aliphatic substituents contains from about 3 to 18 carbon atoms, and at least one aliphatic substituent contains an anionic water-solubilizing group, e.g., carboxy, sulfo, sulfato, phosphato, or phosphono. Examples of zwitterionic surfactants are provided in U.S. Pat. No. 3,664,961, from col. 7, line 65, to col. 8, line 75, and include 3-(N,N-dimethyl-N-hexadecyl-ammonio)-2-hydroxypropane-1-sulfonate, 3-(N,N-dimethyl-N-hexadecylammonio)propane-1-sulfonate, 2-(N,N-dimethyl-N-dodecylammonio)acetate, 3-(N,N-dimethyl-N-dodecylammonio)propionate, 2-(N,N-dimethyl-N-octadecylammonio)-ethyl sulfate, 2-(trimethylammonio)ethyl dodecyl-phosphonate, ethyl 3-(N,N-dimethyl-N-dodecylammonio)-propylphosphonate, 3-(P,P-dimethyl-P-dodecylphosphonio)-propane-1-sulfonate, 2-(S-methyl-S-tert.-hexadecyl-sulfonio)ethane-1-sulfonate, 3-(S-methyl-5-dodecylsulfonio)-propionate, sodium 2-(N,N-dimethyl-N-dodecylammonio)ethyl phosphonate, 4-(S-methyl-8-tetradecylsulfonio)butyrate, 1-(2-hydroxyethyl)-2-undecyl-imidazolium-1-acetate, 2-(trimethylammonio)-octadecanoate and 3-(N,N-bis-(2-hydroxyethyl)-N-octodecylammonio)-2-hydroxy-propane-1-sulfonate. Zwitterionic surfactants can be used as from 1% to 50%, more preferably from 1% to 10%, even more preferably from 1% to 5% by weight of the present formulations.

### Mixtures of Surfactants

Mixtures of any two or more individually contemplated surfactants, whether of the same type or different types, are contemplated herein.

In addition to the surfactants as previously described, a laundry detergent composition commonly contains other ingredients for various purposes. Some of those ingredients are also described below.

### Builders and Alkaline Agents

Builders and other alkaline agents are contemplated for use in the present formulations.

Any conventional builder system is suitable for use here, including aluminosilicate materials, silicates, polycarboxylates and fatty acids, materials such as ethylenediamine tetraacetate, metal ion sequestrants such as aminopolyphosphonates, particularly ethylenediamine tetramethylene phosphonic acid and diethylene triamine pentamethylenephosphonic acid. Though less preferred for obvious environmental reasons, phosphate builders could also be used here.

Suitable polycarboxylate builders for use here include citric acid, preferably in the form of a water-soluble salt, and derivatives of succinic acid of the formula:

R—CH(COOH)CH₂(COOH)

where R is C₁₀₋₂₀ alkyl or alkenyl, preferably C₁₂₋₁₆, or where R can be substituted with hydroxyl, sulfo sulfoxyl or sulfone substituents. Specific examples include lauryl succinate, myristyl succinate, palmityl succinate 2-dodecenylsuccinate, or 2-tetradecenyl succinate. Succinate builders are preferably used in the form of their water-soluble salts, including sodium, potassium, ammonium and alkanolammonium salts.

Other suitable polycarboxylates are oxodisuccinates and mixtures of tartrate monosuccinic and tartrate disuccinic acid, as described in U.S. Pat. No. 4,663,071.

Especially for a liquid detergent composition, suitable fatty acid builders for use here are saturated or unsaturated C₁₀₋₁₈ fatty acids, as well as the corresponding soaps. Preferred saturated species have from 12 to 16 carbon atoms in the alkyl chain. The preferred unsaturated fatty acid is oleic acid. Another preferred builder system for liquid compositions is based on dodecenyl succinic acid and citric acid.

Some examples of alkaline agents include alkalic metal (Na, U, or NH₄) hydroxides, carbonates, bicarbonates. Another commonly used builder is borax.

For powdered detergent compositions, the builder or alkaline agent typically comprises from 1% to 95% of the composition. For liquid compositions, the builder or alkaline agent typically comprises from 1% to 60%, alternatively between 1% and 30%, alternatively between 2% and 15%. See, U.S. Pat. No. 5,929,022; col. 7, start of 2nd paragraph through col. 7, end of 6th paragraph, from which much of the preceding discussion comes. Other builders are described in PCT Publication No. WO 99/05242, which includes phosphates, polyphosphates and sodium salts thereof, carbonates, bicarbonates, sesquicarbonates and other carbonate minerals, tetracarboxylates, potassium or alkanolammonium salts, oligomeric or water-soluble low molecular weight polymer carboxylates, borates, sulfates, fillers or carriers or combinations thereof.

### Enzymes

The detergent compositions of the present technology may further comprise one or more enzymes, which provide cleaning performance and/or fabric, care benefits. Said enzymes include enzymes selected from cellulases, hemicellulases, peroxidases, proteases, gluco-amylases, amylases, lipases, cutinases, pectinases, xylanases, reductases, oxidases, phenoloxidases, lipoxygenases, ligninases, pullulanases, tannases, pentosanases, malanases, beta-glucanases, arabinosidases or mixtures thereof.

A preferred combination is a detergent composition having a cocktail of conventional applicable enzymes like protease, amylase, lipase, cutinase and/or cellulase in conjunction with the lipolytic enzyme variant D96L at a level of from 50 LU to 8500 LU per liter wash solution.

The cellulases usable in the present technology include both bacterial or fungal cellulase. Preferably, they will have a pH optimum of between 5 and 9.5. Suitable cellulases are disclosed in U.S. Pat. No. 4,435,307, Barbesgoard et al, which discloses fungal cellulase produced from Humicola insolens. Suitable cellulases are also disclosed in GB-A-2 075 028; GB-A-2 095 275 and DE-OS-2 247 832.

Examples of such cellulases are cellulases produced by a strain of Humicola insolens (Humicola grisea var. thermoidea), particularly the Humicola strain DSM 1800. Other suitable cellulases are cellulases originated from Humicola insolens having a molecular weight of about 50 KDa, an isoelectric point of 5.5 and containing 415 amino acids. Especially suitable cellulases are the cellulases having color care benefits. Examples of such cellulases are cellulases described in European patent Application No. 91202879.2, filed Nov. 6, 1991 (Novo).

Peroxidase enzymes are used in combination with oxygen sources, e.g. percarbonate, perborate, persulfate, hydrogen peroxide, etc. They are used for “solution bleaching”, i.e. to prevent transfer of dyes or pigments removed from substrates during wash operations to other substrates in the wash solution. Peroxidase enzymes are known in the art, and include, for example, horseradish peroxidase, ligninase, and haloperoxidase such as chloro- and bromo-peroxidase. Peroxidase-containing detergent compositions are disclosed, for example, in PCT International Application WO89/099813 and in European patent Application No. EP 91202882.6, filed Nov. 6, 1991.

Said cellulases and/or peroxidases are normally incorporated in the detergent composition at levels from 0.0001% to 2% of active enzyme by weight of the detergent composition.

Preferred commercially available protease enzymes include those sold under the tradenames Alcalase®, Savinase®, Primase®, Durazym®, and Esperase® by Novo Nordisk A/S (Denmark), those sold under the tradename Maxatase®, Maxacal® and Maxapem® by Gist-Brocades, those sold by Genencor International, and those sold under the tradename Opticlean® and Optimase® by Solvay Enzymes. Other proteases are described in U.S. Pat. No. 5,679,630, issued Oct. 21, 1997 (P&G) can be included in the detergent composition of the present technology. Protease enzyme may be incorporated into the compositions in accordance with the present technology at a level of from about 0.0001% to about 2% active enzyme by weight of the composition.

A preferred protease here referred to as “Protease D” is a carbonyl hydrolase variant having an amino acid sequence not found in nature, which is derived from a precursor carbonyl hydrolase by substituting a different amino acid for the amino acid residue at a position in said carbonyl hydrolase equivalent to position +76, preferably also in combination with one or more amino acid residue positions equivalent to those selected from the group consisting of +99, +101, +103, +104, +107, +123, +27, +105, +109, +126, +128, +135, +156, +166, +195, +197, +204, +206, +210, +216, +217, +218, +222, +260, +265, and/or +274 according to the numbering of Bacillus amyloliquefaciens subtilisin, as described in the patent of A. Baeck et al. entitled “Protease-Containing Cleaning Composition,” U.S. Pat. No. 5,679,630, issued Oct. 21, 1997.

Highly preferred enzymes that can be included in the detergent compositions of the present technology include lipases. It has been found that the cleaning performance on greasy soils is synergistically improved by using lipases. Suitable lipase enzymes include those produced by microorganisms of the Pseudomonas group, such as Pseudomonas stutzeri ATCC 19.154, as disclosed in British Patent No. 1,372,034. Suitable lipases include those which show a positive immunological cross-reaction with the antibody of the lipase, produced by the microorganism Pseudomonas fluorescens IAM 1057. This lipase is available from Amano Pharmaceutical Co. Ltd., Nagoya, Japan, under the trade name Lipase P “Amano,” hereafter referred to as “Amano-P”. Further suitable lipases are lipases such as M1 Lipase®. and Lipomax®. (Gist-Brocades). Highly preferred lipases are the D96L lipolytic enzyme variant of the native lipase derived from Humicola lanuginosa as described in U.S. Pat. No. 6,017,871 issued Jan. 25, 2000 (P&G). Preferably the Humicola lanuginosa strain DSM 4106 is used. This enzyme is incorporated into the composition in accordance with the present technology at a level of from 50 LU to 8500 LU per liter wash solution. Preferably the variant D96L is present at a level of from 100 LU to 7500 LU per liter of wash solution. More preferably at a level of from 150 LU to 5000 LU per liter of wash solution.

By D96L lipolytic enzyme variant is meant the lipase variant as described in patent application WO92/05249 viz. where the native lipase ex Humicola lanuginosa aspartic acid (D) residue at position 96 is changed to Leucine (L). According to this nomenclature said substitution of aspartic acid to Leucine in position 96 is shown as: D96L.

Also suitable are cutinases [EC 3.1.1.50] which can be considered as a special kind of lipase, namely lipases which do not require interfacial activation. Addition of cutinases to detergent compositions have been described in e.g., WO-A-88/09367 (Genencor).

The lipases and/or cutinases are normally incorporated in the detergent composition at levels from 0.0001% to 2% of active enzyme by weight of the detergent composition.

Amylases (α and/or β) can be included for removal of carbohydrate-based stains. Suitable amylases are Termamyl® (Novo Nordisk), Fungamyl® and BAN® (Novo Nordisk).

The above-mentioned enzymes may be of any suitable origin, such as vegetable, animal, bacterial, fungal and/or yeast origin. See, U.S. Pat. No. 5,929,022; col. 7, 7th paragraph through col. 9, 6th paragraph, from which much of the preceding discussion comes. Preferred compositions optionally contain a combination of enzymes or a single enzyme, with the amount of each enzyme commonly ranging from 0.0001% to 2%.

Other enzymes and materials used with enzymes are described in PCT Publication No. WO99/05242, which is incorporated herein by reference.

### Adjuvants

The detergent compositions optionally contain one or more soil suspending agents or resoiling inhibitors in an amount from about 0.01% to about 5% by weight, alternatively less than about 2% by weight. Resoiling inhibitors include anti-redeposition agents, soil release agents, or combinations thereof. Examples of suitable agents are described in U.S. Pat. No. 5,929,022; col. 10, 3rd paragraph through col. 10, 5th paragraph, and include water-soluble ethoxylated amines having clay soil removal and anti-redeposition properties. Examples of such soil release and anti-redeposition agents given in the referenced patent include an ethoxylated tetraethylenepentamine. The ethoxylated amines further described in U.S. Pat. No. 4,597,898, VanderMeer, issued Jul. 1, 1986, include ethoxylated monoamines, ethoxylated diamines, ethoxylated polyamines, ethoxylated amine polymers and mixtures thereof. Another group of preferred clay soil removal/anti-redeposition agents are the cationic compounds disclosed in European patent Application No. 111,965, Oh and Gosselink, published Jun. 27, 1984, which include ethoxylated cationic monoamines, ethoxylated cationic diamines, ethoxylated cationic polymers which comprise a polymer backbone and mixtures thereof. Other clay soil removal/anti-redeposition agents which can be used include the ethoxylated amine polymers disclosed in European patent Application No. 111,984, Gosselink published Jun. 27, 1984, which include polymers comprising a polymer backbone other than a polyalkyleneamine backbone, at least 2 M groups and at least one L-X group, wherein M is a tertiary amine group attached to or integral with the backbone, X is a nonionic group, anionic group of mixture thereof, and L is a hydrophilic chain connecting groups M and X or connecting X to the backbone; the zwitterionic polymers disclosed in European patent Application No. 112,592, Gosselink, published Jul. 4, 1984, which include polymers comprising a polymer backbone, at least 2 M groups and at least one L-X group, wherein M is a cationic group attached to or integral with the backbone and contains an N+ positively charged center, X is an anionic group or a mixture of anionic groups M and X or connecting X to the backbone and L contains the polyoxyalkylene moiety —[(R′O)ₘ(CH₂CH₂O)ₙ]—; and the amine oxides disclosed in U.S. Pat. No. 4,548,744, Connor, issued Oct. 22, 1985, which include ethoxylated monoamine oxides, ethoxylated amine oxides, ethoxylated amine oxide polymers and mixtures thereof.

Other clay soil removal and/or anti-redeposition agents known in the art can also be utilized in the compositions hereof. Another type of preferred anti-redeposition agent includes the carboxymethylcellulose (CMC) materials.

For example, optionally, anti-redeposition polymers can be incorporated into HDL formulations covered by the presently described technologies. In at least some embodiments, it is preferred to keep the level of anti-redeposition polymer below about 2%. It has been found that at levels above about 2%, anti-redeposition polymer may cause formulation instability (e.g. phase separation) and or undue thickening.

Soil release agents are also contemplated as optional ingredients in the amount of about 0.1% to about 5%. See, U.S. Pat. No. 5,929,022; col. 9, 8th paragraph through col. 10, end of 1st partial paragraph.

Chelating agents in the amounts of about 0.1% to about 10%, more preferably about 0.5% to about 5% and even more preferably from about 0.8% to about 3% are also contemplated as an optional ingredient. See, U.S. Pat. No. 5,929,022; col. 10, 1st paragraph to col. 10, end of 2nd paragraph.

Polymeric dispersing agents in the amount of 0% to about 6% are also contemplated as an optional component of the presently described detergent compositions. See, U.S. Pat. No. 5,929,022; col. 10, start of 7th paragraph to col. 10, end of the continuing paragraph from that started on the previous column and include polymeric polycarboxylates, polyethylene glycols, derivatives of stilbene, pyrazoline, coumarin, carboxylic acid, methinecyanines, dibenzothipene-5,5-dioxide, azoles, 5- and 6-membered ring heterocycles and other miscellaneous agents.

Other ingredients that can be included in a liquid laundry detergent include perfumes that optionally contain ingredients such as aldehydes, ketones, esters, and alcohols. More compositions that can be included are: carriers, hydrotropes, processing aids, dyes, pigments, solvents, bleaches, bleach activators and enzyme stabilizing packaging systems.

The co-surfactant technology of U.S. Pat. No. 4,561,998 can be used in conjunction with the present technology, for the reasons explained in that patent. Co-surfactants and fatty acids identified in U.S. Pat. No. 4,561,998 that can be used in conjunction with anionic surfactants to improve laundering performance include, for example, chloride, bromide and methylsulfate C₈₋₁₆ alkyl trimethylammonium salts, C₈₋₁₆ alkyl di(hydroxyethyl)methylammonium salts, C₈₋₁₆ alkyl hydroxyethyldimethylammonium salts, and C₈₋₁₆ alkyloxypropyl trimethylammonium salts.

Similar to what is taught in U.S. Pat. No. 4,561,998, the compositions herein can also contain from about 0.25% to about 12%, preferably from about 0.5% to about 8%, more preferably from about 1% to about 4%, by weight of a cosurfactant selected from the group of certain quaternary ammonium, diquaternary ammonium, amine, diamine, amine oxide and di(amine oxide) surfactants. The quaternary ammonium surfactants are particularly preferred.

Quaternary ammonium surfactants can have the following formula:

[R²(OR³)_{y}][R⁴(OR³)_{y}]₂R⁵N⁺X⁻

wherein R² is an alkyl or alkyl benzyl group having from about 8 to about 18 carbon atoms in the alkyl chain; each R³ is selected from the group consisting of —CH₂CH₂—, —CH₂CH(CH₃)—, —CH₂CH(CH₂OH)—, —CH₂CH₂CH₂—, and mixtures thereof; each R⁴ is selected from the group consisting of C₁₋₄ alkyl, C₁₋₄ hydroxyalkyl, benzyl, ring structures formed by joining the two R⁴ groups, —CH₂CHOHCHOHCOR⁶CHOHCH₂OH wherein R⁶ is any hexose or hexose polymer having a molecular weight less than about 1000, and hydrogen when y is not 0; R⁵ is the same as R⁴ or is an alkyl chain wherein the total number of carbon atoms of R² plus R⁵ is not more than about 18; each y is from 0 to about 10 and the sum of the y values is from 0 to about 15; and X is any compatible anion.

Preferred of the above are the alkyl quaternary ammonium surfactants, especially the mono-long chain alkyl surfactants described in the above formula when R⁵ is selected from the same groups as R⁴. The most preferred quaternary ammonium surfactants are the chloride, bromide and methylsulfate C₈₋₁₆ alkyl trimethylammonium salts, C₈₋₁₆ alkyl di(hydroxyethyl)methylammonium salts, C₈₋₁₆ alkyl hydroxyethyldimethylammonium salts, and C₈₋₁₆ alkyloxypropyl trimethylammonium salts. Of the above, decyl trimethylammonium methylsulfate, lauryl trimethylammonium chloride, myristyl trimethylammonium bromide and coconut trimethylammonium chloride and methylsulfate are particularly preferred.

U.S. Pat. No. 4,561,998 also provides that under cold water washing conditions, i.e., less than about 65° F. (18.3° C.), the C₈₋₁₀ alkyltrimethyl ammonium surfactants are particularly preferred since they have a lower Kraft boundary and, therefore, a lower crystallization temperature than the longer alkyl chain quaternary ammonium surfactants herein.

Diquaternary ammonium surfactants can be of the formula:

[R²(OR³)_{y}][R⁴OR³]_{y}]₂N⁺R³N⁺R⁵[R⁴(OR³)_{y}]₂(X⁻)₂

wherein the R², R³, R⁴, R⁵, y and X substituents are as defined above for the quaternary ammonium surfactants. These substituents are also preferably selected to provide diquaternary ammonium surfactants corresponding to the preferred quaternary ammonium surfactants. Particularly preferred are the C₈₋₁₆ alkyl pentamethylethylenediammonium chloride, bromide and methylsulfate salts.

Amine surfactants useful herein are of the formula:

[R²(OR³)_{y}][R⁴(OR³)_{y}]R⁵N

wherein the R², R³, R⁴, R⁵ and y substituents are as defined above for the quaternary ammonium surfactants. Particularly preferred are the C₁₂₋₁₆ alkyl dimethyl amines.

Diamine surfactants herein are of the formula

[R²(OR³)_{y}][R⁴(OR³)_{y}]NR³NR⁵[R⁴(OR³)_{y}]

wherein the R², R³, R⁴, R⁵ and y substituents are as defined above. Preferred are the C₁₂₋₁₆ alkyl trimethylethylene diamines.

Amine oxide surfactants useful herein are of the formula:

[R²(OR³)_{y}][R⁴(OR³)_{y}]R⁵N→O

wherein the R², R³, R⁴, R⁵ and y substituents are also as defined above for the quaternary ammonium surfactants. Particularly preferred are the C₁₂₋₁₆ alkyl dimethyl amine oxides.

Di(amine oxide) surfactants herein are of the formula:

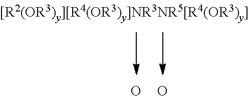

wherein the R², R³, R⁴, R⁵ and y substituents are as defined above, preferably is C₁₂₋₁₆ alkyl trimethylethylene di(amine oxide).

Other common cleaning adjuncts are identified in U.S. Pat. No. 7,326,675, col. 12, and PCT Publication No. WO 99/05242 (pp. 29-56). Such cleaning adjuncts are identified as including bleaches, bleach activators, bleach boosters, bleach catalysts, bleaching agents, catalytic materials, suds builders, suds suppressors, dispersant polymers (e.g., from BASF Corp. or Rohm & Haas) other than those described above, color speckles, silvercare, anti-tarnish and/or anti-corrosion agents, pigments, dyes, fillers, germicides, alkinity sources, hydrotropes, anti-oxidants, enzyme stabilizing agents, pro-perfumes, perfumes, solubilizing agents, pigments, carriers, processing aids, solvents, chelating agents, dispersants, dye transfer inhibiting agents, brighteners, structure elasticizing agents, alkoxylated polycarboxylates, fabric softeners, anti-abrasion agents, and other fabric care agents, surface and skin care agents. Suitable examples of such other cleaning adjuncts and levels of use are found in U.S. Pat. Nos. 5,576,282, 6,306,812 B1 and 6,326,348 B1 and PCT Publication No. WO99/05242.

### Fatty Acid

Similar to that disclosed in U.S. Pat. No. 4,561,998, the compositions of the present technology may contain from about 5% to about 40%, preferably from about 7% to about 30%, most preferably from about 10% to about 20%, by weight of a fatty acid containing from about 10 to about 22 carbon atoms. The fatty acid can also contain from about 1 to about 10 ethylene oxide units in the hydrocarbon chain.

Suitable fatty acids are saturated and/or unsaturated and can be obtained from natural sources such as plant or animal esters (e.g., palm kernel oil, palm oil, coconut oil, babassu oil, safflower oil, tall oil, castor oil, tallow and fish oils, grease, and mixtures thereof) or synthetically prepared (e.g., via the oxidation of petroleum or by hydrogenation of carbon monooxide via the Fisher-Tropsch process). Examples of suitable saturated fatty acids for use in the compositions of the present technology include, but are not limited to capric, lauric, myristic, palmitic, stearic, arachidic and behenic acid. Suitable unsaturated fatty acid species include: palmitoleic, oleic, linoleic, linolenic and ricinoleic acid. Examples of preferred fatty acids are saturated C₁₀-C₁₄ (coconut) fatty acids, from about 5:1 to about 1:1 (preferably about 3:1) weight ratio mixtures of lauric and myristic acid, and mixtures of the above lauric/myristic blends with oleic acid at a weight ratio of about 4:1 to about 1:4 mixed lauric/myristic:oleic.

U.S. Pat. No. 4,507,219 identifies various sulfonate surfactants as suitable for use with the above-identified co-surfactants. The sulfonate surfactants of U.S. Pat. Nos. 4,561,998 and 4,507,219 include, for example, alkali metal and alkanolamonium salts of alkylbenzene sulfonates in which the alkyl group contains from about 10 to about 15 carbon atoms in a straight chain or branched configuration; and water-soluble salts of paraffin sulfonates, olefin sulfonates, alkyl glyceryl ether sulfonates, esters of a-sulfonated fatty acids containing from about 1 to 10 carbon atoms in the ester group, 2-acyloxy-alkane-1-sulfonates containing from about 2 to 9 carbon atoms in the acyl group, and β-alkyloxy alkane sulfonates containing from about 1 to 3 carbon atoms in the alkyl group.

### Softergent

Softergent technologies as described in, for example, U.S. Pat. Nos. 6,949,498, 5,466,394 and 5,622,925 can be used in compositions of the present technology. The term “softergent” refers to a softening detergent that can be dosed at the beginning of a wash cycle for the purpose of simultaneously cleaning and softening fabrics. The sulfonated estolides of fatty acids of the present technology can be used to make stable, aqueous heavy duty liquid laundry detergent compositions containing a fabric-softening agent that provide exceptional cleaning as well as fabric softening and anti-static benefits.

For example, a softergent composition of the present technology can contain about 0.5% to about 10%, preferably from about 2% to about 7%, more preferably from about 3% to about 5% by weight of a quaternary ammonium fabric-softening agent having the formula:

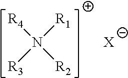

wherein R₁ and R₂ are individually selected from the group consisting of C₁-C₄ alkyl, C₁-C₄ hydroxy alkyl, benzyl, and —(C₂H₄O)ₓH where x has a value from 2 to 5; X is an anion; and (1) R₃ and R₄ are each a C₈-C₁₄ alkyl or (2) R₃ is a C₈-C₂₂ alkyl and R₄ is selected from the group consisting of C₁-C₁₀ alkyl, C-C₁₀ hydroxy alkyl, benzyl, and —(C₂H₄O)ₓH where x has a value from 2 to 5.

Preferred fabric-softening agents are the mono-long chain alkyl quaternary ammonium surfactants wherein the above formula R₁, R₂, and R₃ are each methyl and R₄ is a C₈-C₁₈ alkyl. The most preferred quaternary ammonium surfactants are the chloride, bromide and methylsulfate C₈₋₁₆ alkyl trimethyl ammonium salts, and C₈₋₁₆ alkyl di(hydroxyethyl)-methyl ammonium salts. Of the above, lauryl trimethyl ammonium chloride, myristyl trimethyl ammonium chloride and coconut trimethylammonium chloride and methylsulfate are particularly preferred. For example, ADOGEN 412™, a lauryl trimethyl ammonium chloride commercially available from Witco, is a preferred softening agent.

Another class of preferred quaternary ammonium surfactants are the di-C₈-C₁₄ alkyl dimethyl ammonium chloride or methylsulfates; particularly preferred is di-C₁₂-C₁₄ alkyl dimethyl ammonium chloride. This class of materials is particularly suited to providing antistatic benefits to fabrics. Materials having two alkyl chain lengths longer than C₁₄, like di-C₁₆-C₁₈ alkyl dimethyl ammonium chloride, which are commonly used in rinse added fabric softeners, are not included in the presently described technology, since they do not yield isotropic liquid detergents when combined with the anionic surfactants described above.

A preferred softergent embodiment of the present technology comprises the detergent composition wherein the weight ratio of anionic surfactant component to quaternary ammonium softening agent is from about 3:1 to about 40:1 and a preferred range from about 5:1 to 20:1.

The compositions of the present technology are illustrated by the following examples. Examples stated in the present or future tense are not represented as having been carried out.

### Example 1

### Preparation of a Bleached Aqueous Concentrate of Sulfo-Estolide (SE) Sodium Salts

The feedstock used in this example had an equivalent weight of about 270.18 and was comprised of about 78% C-18:1, about 12% C-18:2, and about 9% saturated fatty acids. The feedstock was sulfonated on a falling film reactor at a rate of about 129.9 lbs per hour using a molar ratio of SO₃ to alkene functionality of about 0.95. The SE sulfonic acid was continuously neutralized in a loop reactor with concurrent addition of about 36.8 lbs per hour of 50% aqueous NaOH and about 26.9 lbs per hour of water. The temperature of the reaction mixture in the loop reactor was about 50° C. Neutralized SE solution was transferred to a stirred tank reactor and warmed to 80° C. Once at this temperature, four additions of 5.9 lbs of 50% aqueous hydrogen peroxide were added to the reactor over a 1.5 hour period. The total hydrogen peroxide charge was about 23.6 lbs. (about 3% active hydrogen peroxide by wt.). The pH of the SE solution was maintained around 5.8 throughout the process by the addition of 50% aqueous NaOH. After the final addition of hydrogen peroxide, the solution was stirred at about 85° C. for 2 hours and then the temperature was slowly raised to about 97° C. This temperature was maintained until the residual active peroxide had dropped to about 0.085% by wt. The solution was cooled and about 1.38 lbs of 40% aqueous sodium bisulfite was added to reduce the amount of residual active peroxide. The SE produced from this reaction was at a pH of about 5.69, was comprised of about 68.22% solids and about 5-10 ppm active peroxide, and had a Klett color at 5 percent solids concentration of 71. The SE of this example is used in some of the following laundry detergent formulas.

### Example 2

The following Heavy Duty Liquid (HDL) laundry detergents were made:

% Inclusion by Weight
(100% Active)

| Ingredient | Formula 1 | Formula 2 |
|---|---|---|
| SE | | 18.0 |
| Na LAS | 7.0 | |
| Alcohol ethoxy sulfate | 11.0 | |
| C₁₂₋₁₅EO₇ | 16.0 | 16.0 |
| C₁₂dimethyl amine oxide | 1.0 | 1.0 |
| Coconut fatty acid | 1.0 | 1.0 |
| Borax pentahydrate | 2.25 | 2.25 |
| Propylene glycol | 2.0 | 2.0 |
| Citric acid | 2.0 | 2.0 |
| Monoethanolamine | 0.75 | 0.75 |
| Triethanolamine | 0.75 | 0.75 |
| Protease (Savinase 16L; Novozyme) | 1.1 | 1.1 |
| Amylase (Termamyl 300L; Novozyme) | 0.55 | 0.55 |
| Neolone M-10 | 0.0075 | 0.0075 |
| Water | 54.6 | 54.6 |

| | |
|---|---|
| pH | 8.5-9.0 |

Each of Formulas 1 and 2 was evaluated for foam generation using the following procedure:

### Test for Foam Generation

Foam volume is measured via a shake foam test. A 0.2% aqueous solution of a liquid cleaning composition is made in 140 ppm hardness water. 100 ml of the aqueous solution is added to a 500 ml, stoppered graduated cylinder. The cylinder is firmly attached to a mechanical arm having a motor. The mechanical arm is then set to invert the cylinder 10 times at a preset speed and force. After the 10^{th} inversion cycle is complete, a stopwatch is started and the level of liquid plus foam is measured at the 5 second mark. This is termed the Shaken Volume. For example, if there were no foam, the Shaken Volume would be 100 ml (the starting volume of the liquid).

Formula 1 had a measured Shaken Volume of greater than 300 ml while Formula 2 had a Shaken Volume of 115 ml. Despite the fact that Formula 2 had a significant quantity of high foaming co-surfactant (C₁₂₋₁₅EO₇), the overall foam profile was very low. This demonstrates how difficult it is to get SE-containing liquid cleaning compositions to generate foam.

### Example 3

The following HDL formulas were also made:

| | % Inclusion by Weight | |
|---|---|---|
| | (100% Active) | |
| Ingredient | Formula 3 | Formula 4 |
| SE | 17.8 | 17.8 |
| Mirapol A-15 (polyquaternium-2 from Rhodia) | 0.3 | |
| Merquat 550 (Polyquaternium-7 from Nalco) | | 0.3 |
| C₁₂₋₁₅EO₇ | 15.9 | 15.9 |
| C₁₂dimethyl amine oxide | 1.0 | 1.0 |
| Coconut fatty acid | 1.0 | 1.0 |
| Borax pentahydrate | 2.25 | 2.25 |
| Propylene glycol | 2.0 | 2.0 |
| Citric acid | 2.0 | 2.0 |
| Monoethanolamine | 0.75 | 0.75 |
| Triethanolamine | 0.75 | 0.75 |
| Protease (Savinase 16L; Novozyme) | 1.1 | 1.1 |
| Amylase (Termamyl 300L; Novozyme) | 0.55 | 0.55 |
| Neolone M-10 | 0.0075 | 0.0075 |
| Water | 54.6 | 54.6 |

| | |
|---|---|
| pH | 8.5-9.0 |

Each of Formulas 3 and 4 was evaluated for foam generation using the same foam generation test described in Example 2.

The Shaken Volumes were as follows:

### Formula 3: 320 ml

### Formula 4: 330 ml

These results demonstrate the foam boosting ability of the incorporated cationic polymers. When an effective amount of cationic polymer is incorporated into the SE-containing composition, the Shaken Volume is typically greater than 200 ml, and in this case is greater than 300 ml.

Further HDL formulas were made:

| | % Inclusion by Weight | | |
|---|---|---|---|
| | (100% Active) | | |
| | For- | For- | For- |
| Ingredient | mula 5 | mula 6 | mula 7 |
| SE | 15.0 | 14.8 | 14.8 |
| C₁₂₋₁₅EO₇ | 5.0 | 4.9 | 4.9 |
| Mirapol A-15 (polyquaternium-2 from | | 0.3 | |
| Rhodia) | | | |
| Merquat 550 (Polyquaternium-7 from Nalco) | | | 0.3 |
| Citric acid | 1.0 | 1.0 | 1.0 |
| Monoethanolamine | 1.0 | 1.0 | 1.0 |
| Triethanolamine | 1.0 | 1.0 | 1.0 |
| Sodium Xylene Sulfonate | 2.0 | 2.0 | 2.0 |
| Neolone M-10 | 0.0075 | 0.0075 | 0.0075 |
| Water | 77.0 | 77.0 | 77.0 |

| | |
|---|---|
| pH | 10.0 |

Each of the Formulas 5, 6 and 7 was evaluated for foam generation using the foam generation test described in Example 2.

The Shaken Volumes were as follow:

### Formula 5: 115 ml

### Formula 6: 300 ml

### Formula 7: 310 ml

These results demonstrate the foam boosting ability of the incorporated cationic polymers.

### Example 5

### Premium/Mid-Tier Formulations A-GG

The following prophetic formulas, in Table 1, are intended to cover liquid laundry detergent formulas in the Premium/Mid-Tier range. Unless more narrowly defined in the table, the pH of these formulas is between a pH of about 7 to about 10, preferably between about 7.5 to about 9.5 and most preferably between about 8.5 to about 9.0. These formulas are not intended to be limiting in any way—optional ingredients described herein regarding the present technology can be added in the proportions described. In each case, these are intended to be liquid detergent formulas and, after the addition of optional ingredients, water would be used to bring the total weight up to 100%. For each of the following formulas, prior to adding water to bring the total weight up to 100%, one or more cationic polymers are added to the formulas so that the total amount of cationic polymers is in the range of about 0.01% to about 10% by weight of the composition.

TABLE 1

| | % Inclusion by Weight (Based on 100% Active) | | | | | | | | | |
|---|---|---|---|---|---|---|---|---|---|---|
| | Generic | | | | | | | | | |
| Ingredient* | Formula | A | B | C | D | E | F | G | H | I |
| SE, PHSE, HSE | 2-90 | 23 | 23 | 5.6 | 23 | 23 | 21 | 29 | 29 | 38 |
| Nonionic surfactant | 2-40 | 14 | 14 | 14 | 14 | 14 | 12 | 16 | 16 | 18 |
| AES | 0-35 | | | 17.4 | | | | | | |
| C16MES | 0-25 | | | | | | | | | |
| Cocoamide DEA | 0-25 | | | | | | | | | |
| AMMONYX ® LO | 0-6 | | | | | | 2 | | | |
| C₁₂EO₃ | 0-6 | | | | | | 2 | | | |
| Coconut fatty acid | 0-10 | | | | | | | | | |
| Borax pentahydrate | 0-3 | 2.7 | 2.7 | 2.7 | | 2.7 | 2.7 | 2.2 | 2.2 | 1.5 |
| Propylene glycol | 0-6 | 2.6 | 2.6 | 2.6 | 4.0 | 2.6 | 2.6 | 2.1 | 2.1 | 1.4 |
| Calcium chloride | 0-2 | | | | 0.2 | | | | | |
| Glycerol | 0-6 | | | | | | | | | |
| Sodium citrate | 0-10 | 3.9 | 3.9 | 3.9 | 3.9 | 3.9 | 3.9 | 3.9 | 3.9 | 5.0 |
| Triethanolamine | 0-6 | | | | | | | | | |
| Monoethanolamine | 0-6 | 3.5 | 3.5 | 3.5 | 3.5 | 3.5 | 3.5 | 3.5 | 3.5 | 4.5 |
| Fluorescent whitening | 0-1 | 0.15 | 0.15 | 0.15 | 0.15 | 0.15 | 0.15 | 0.15 | 0.15 | 0.2 |
| agent (FWA) | | | | | | | | | | |
| Anti-redeposition agent | 0-1.5 | | | | | 0.8 | 0.8 | | 0.8 | |
| Thickener | 0-2 | 0.25 | 0.25 | 0.15 | 0.2 | 0.2 | 0.2 | | | |
| Thinner | 0-20 | | | | | | | | | 1-3 |
| Protease | 0-2 | 0.8 | 0.8 | 0.8 | 0.8 | 0.8 | 0.8 | 0.8 | 0.8 | 1.1 |
| Amylase | 0-2 | 0.4 | 0.4 | 0.4 | 0.4 | 0.4 | 0.4 | 0.4 | 0.4 | 0.55 |
| Lipase | 0-2 | 0.2 | | | | | | | | |
| Mannanase | 0-2 | 0.1 | | | | | | | | |
| Cellulase | 0-2 | 0.02 | | | | | | | | |
| pH | | 7.0-7.5 | | | | | | | | |
| | % Inclusion by Weight (Based on 100% Active) | | | | | | | | | |
| Ingredient* | J | K | L | M | N | O | P | Q | R | S |
| SE, PHSE, HSE | 38 | 38 | 38 | 46 | 46 | 46 | 6 | 11.4 | 6 | 11.4 |
| Nonionic surfactant | 11 | 18 | 11 | 24 | 14 | 14 | 10 | 10 | 10 | 10 |
| AES | | | | | | | 5.4 | | 5.4 | |
| C16MES | | | | | | | | | | |
| Cocoamide DEA | | | | | | | | | | |
| AMMONYX ® LO | | | | | | | 1 | 1 | 1 | 1 |
| C₁₂EO₃ | 7 | | 7 | | 10 | 10 | | | | |
| Coconut fatty acid | | | | | | | 1 | | 1 | |
| Borax pentahydrate | 1.5 | 1.5 | 1.5 | | 0.5 | 0.5 | | 2.2 | | |
| Propylene glycol | 1.4 | 1.4 | 1.4 | 3.0 | 1.0 | 1.0 | 2.1 | 2.1 | | |
| Calcium chloride | | | | 0.1 | | | 0.15 | | | |
| Glycerol | | | | | | | | | | |
| Sodium citrate | 5.0 | 5.0 | 5.0 | 5.0 | 5.0 | 5.0 | 1.4 | 1.4 | 3.5 | 3.5 |
| Triethanolamine | | | | | | | 0.52 | 0.52 | 0.52 | 0.52 |
| Monoethanolamine | 4.5 | 4.5 | 4.5 | 4.5 | 4.5 | 4.5 | 0.53 | 0.53 | 0.53 | 0.53 |
| Fluorescent whitening | 0.2 | 0.2 | 0.2 | 0.2 | 0.2 | 0.2 | 0.15 | 0.15 | 0.15 | 0.15 |
| agent (FWA) | | | | | | | | | | |
| Anti-redeposition agent | | | | | | | | | | |
| Thickener | | | | | | | 0.15 | 0.25 | 0.15 | 0.25 |
| Thinner | | 1-3 | | 3-7 | | 2-5 | | | | |
| Protease | 1.1 | 1.1 | 1.1 | 1.2 | 1.2 | 1.2 | 0.6 | 0.6 | | |
| Amylase | 0.55 | 0.55 | 0.55 | 0.6 | 0.6 | 0.6 | 0.3 | 0.3 | | |
| Lipase | | 0.25 | 0.25 | | | | | | | |
| Mannanase | | 0.13 | 0.13 | | | | | | | |
| Cellulase | | 0.02 | 0.02 | | | | | | | |
| pH | 7.0-7.5 | | | | | | | | | |
| | % Inclusion by Weight (Based on 100% Active) | | | | | | | | | |
| Ingredient* | T | U | V | W | X | Y | Z | AA | BB | CC |
| SE, PHSE, HSE | 11.4 | 29 | 38 | 38 | 46 | 6.4 | 12.4 | 12.4 | 10.4 | 25 |
| Nonionic surfactant | 10 | 16 | 18 | 11 | 14 | | | | | |
| AES | | | | | | 6 | | | | |
| C16MES | | | | | | 4 | 4 | 4 | 4 | 11 |
| Cocoamide DEA | | | | | | 9.8 | 9.8 | 9.8 | 9.8 | 17 |
| AMMONYX ® LO | | | | | | | | | 2 | 2 |
| C₁₂EO₃ | | | | 7 | 10 | | | | | |
| Coconut fatty acid | | | | | | | | | | |
| Borax pentahydrate | | | | | | 1.7 | 1.7 | | 1.7 | 1.2 |
| Propylene glycol | | | | | | | | | | |
| Calcium chloride | | | | | | | | 0.15 | | |
| Glycerol | | | | | | 4.6 | 4.6 | 5.5 | 4.6 | 3 |
| Sodium citrate | 3.5 | 3.9 | 5.0 | 5.0 | 5.0 | | | | | |
| Triethanolamine | 0.52 | | | | | | | | | |
| Monoethanolamine | 0.53 | 3.5 | 4.5 | 4.5 | 4.5 | | | | | |
| Fluorescent whitening | 0.15 | 0.15 | 0.2 | 0.2 | 0.2 | 0.15 | 0.15 | 0.15 | 0.15 | 0.15 |
| agent (FWA) | | | | | | | | | | |
| Anti-redeposition agent | | | | | | | | | | |
| Thickener | 0.25 | | | | | 0.1 | 0.25 | 0.25 | 0.25 | |
| Thinner | | | 1-3 | | | | | | | |
| Protease | | | | | | 0.6 | 0.6 | 0.6 | 0.6 | 1 |
| Amylase | | | | | | 0.3 | 0.3 | 0.3 | 0.3 | 0.5 |
| Lipase | | | | | | | | | 0.2 | |
| Mannanase | | | | | | | | | 0.1 | |
| Cellulase | | | | | | | | | 0.02 | |
| pH | | | | | | | | | | |

% Inclusion by Weight
(Based on 100% Active)

| Ingredient* | DD | EE | FF | GG |
|---|---|---|---|---|
| SE, PHSE, HSE | 27 | 25 | 27 | 35 |
| Nonionic surfactant | | | | |
| AES | | | | |
| C16MES | 11 | 11 | 11 | 13 |
| Cocoamide DEA | 17 | 10 | 10 | 12 |
| AMMONYX ® LO | | 2 | | |
| C₁₂EO₃ | | 7 | 7 | 10 |
| Coconut fatty acid | | | | |
| Borax pentahydrate | 1.2 | 1.2 | 1.2 | 1.2 |
| Propylene glycol | | | | |
| Calcium chloride | | | | |
| Glycerol | 3 | 3 | 3 | 3 |
| Sodium citrate | | | | |
| Triethanolamine | | | | |
| Monoethanolamine | | | | |
| Fluorescent whitening agent (FWA) | 0.2 | 0.2 | 0.2 | 0.2 |
| Anti-redeposition agent | | | | |
| Thickener | | | | |
| Thinner | | | | |
| Protease | 1 | 1 | 1 | 1 |
| Amylase | 0.5 | 0.5 | 0.5 | 0.5 |
| Lipase | | | | |
| Mannanase | | | | |
| Cellulase | | | | |
| pH | | | | |

*A preferred nonionic surfactant is BIO-SOFT ® N25-7, Stepan Company. A preferred AES is STEOL ® CS-460, Stepan Company. A preferred FWA is TINOPAL CBS-X, Ciba. A preferred thickener is Cellosize QP 100MH, Dow. Preferred thinners include: C₁₂EO₂, C₁₂EO₃ (in addition to that already included in certain formulas in the table), ethanol, isopropanol, sodium xylene sulfonate, sodium cumene sulfonate, 2-methoxy ethanol, 2-butoxyethanol, methoxy ethoxy ethanol and combinations of these. A preferred preservative for these formulas is Neolone M-10 from Rohm and Haas used at 75 ppm on a 100% active basis.

### Example 6

### Bargain Formulations A-EE

The following prophetic formulas, in Table 2, are intended to cover liquid laundry detergent formulas in the bargain range. Unless more narrowly defined in the table, the pH of these formulas is between pH 10 and 12.5, preferably between 11.0 and 12.0 and most preferably between 11.3 and 11.8. These formulas are not intended to be limiting in any way—optional ingredients described herein regarding the present technology can be added in the proportions described. In each case, these are intended to be liquid detergent formulas and, after the addition of optional ingredients, water would be used to bring the total weight up to 100%. For each of the formulas, prior to adding water to bring the total weight up to 10%, one or more cationic polymers are added to the formulas so that the total amount of cationic polymers is in the range of about 0.01% to about 10% by weight of the composition.

TABLE 2

| | % Inclusion by Weight (Based on 100% Active) | | | | | | | | | |
|---|---|---|---|---|---|---|---|---|---|---|
| | Generic | | | | | | | | | |
| Ingredient* | Formula | A | B | C | D | E | F | G | H | I |
| SE, PHSE, HSE | 2-90 | 1 | 7.3 | 5.5 | 5.5 | 5.5 | 3 | 14 | 28 | 37 |
| Nonionic | 2-40 | 6 | 6 | 10 | 10 | 8 | 12 | 12 | 24 | 28 |
| surfactant | | | | | | | | | | |
| AES | 0-35 | 6.3 | | | | | 11 | | | |
| AMMONYX ® | 0-6 | | | 1.5 | 1.5 | | | | | |
| LO | | | | | | | | | | |
| C₁₂EO₃ | 0-6 | | | 2 | 2 | 4 | | | | |
| Coconut fatty acid | 0-10 | 0.2 | | | | | | | | |
| Sodium | 0-10 | | | | | | | | | |
| metasilicate | | | | | | | | | | |
| Sodium carbonate | 0-10 | 3 | 3 | 3 | 3 | 3 | 6 | 6 | 7 | 8 |
| Fluorescent | 0-1 | 0.15 | 0.15 | 0.15 | 0.15 | 0.15 | 0.2 | 0.2 | 0.2 | 0.25 |
| whitening agent | | | | | | | | | | |
| (FWA) | | | | | | | | | | |
| Anti-redeposition | 0-1.5 | | | | 0.5 | | | | | |
| agent | | | | | | | | | | |
| Thickener | 0-2 | 0.05 | 0.35 | 0.35 | 0.35 | 0.35 | 0.2 | 0.35 | | |
| Thinner | 0-20 | | | | | | | | | |
| pH | | | | | | | | | | |
| | % Inclusion by Weight (Based on 100% Active) | | | | | | | | | |
| Ingredient* | J | K | L | M | N | O | P | Q | R | S |
| SE, PHSE, HSE | 37 | 35 | 37 | 35 | 45 | 43 | 45 | 43 | 7 | 14 |
| Nonionic | 28 | 28 | 18 | 18 | 30 | 30 | 17 | 17 | 13 | 13 |
| surfactant | | | | | | | | | | |
| AES | | | | | | | | | 7 | |
| AMMONYX ® | | 2 | | 2 | | 2 | | 2 | | |
| LO | | | | | | | | | | |
| C₁₂EO₃ | | | 10 | 10 | | | 13 | 13 | | |
| Coconut fatty acid | | | | | | | | | | |
| Sodium | | | | | | | | | 3 | 3 |
| metasilicate | | | | | | | | | | |
| Sodium carbonate | 8 | 8 | 8 | 8 | 8 | 8 | 8 | 8 | | |
| Fluorescent | 0.25 | 0.25 | 0.25 | 0.25 | 0.25 | 0.25 | 0.25 | 0.25 | 0.2 | 0.2 |
| whitening agent | | | | | | | | | | |
| (FWA) | | | | | | | | | | |
| Anti-redeposition | | | | | | | | | | |
| agent | | | | | | | | | | |
| Thickener | | | | | | | | | 0.2 | 0.35 |
| Thinner | 3 | 3 | | | 5 | 5 | | | | |

| | |
|---|---|
| pH | 11.5 to 12.0 |

| | % Inclusion by Weight (Based on 100% Active) | | | | | | | | | | | |
|---|---|---|---|---|---|---|---|---|---|---|---|---|
| Ingredient* | T | U | V | W | X | Y | Z | AA | BB | CC | DD | EE |
| SE, PHSE, HSE | 12.5 | 14 | 28 | 37 | 37 | 35 | 35 | 45 | 45 | 43 | 43 | 4.5 |
| Nonionic surfactant | 11 | 9 | 24 | 28 | 21 | 28 | 28 | 30 | 17 | 30 | 17 | 4.5 |
| AES | | | | | | | | | | | | |
| AMMONYX ® LO | 1.5 | | | | | 2 | 2 | | | 2 | 2 | |
| C₁₂EO₃ | 2 | 4 | | | 7 | | 7 | | 13 | | 13 | |
| Coconut fatty acid | | | | | | | | | | | | |
| Sodium metasilicate | 3 | 3 | 6 | 6 | 6 | 6 | 6 | 7 | 7 | 7 | 7 | |
| Sodium carbonate | | | | | | | | | | | | 1.3 |
| Fluorescent | 0.2 | 0.2 | 0.25 | 0.25 | 0.25 | 0.25 | 0.25 | 0.25 | 0.25 | 0.25 | 0.25 | 0.1 |
| whitening agent | | | | | | | | | | | | |
| (FWA) | | | | | | | | | | | | |
| Anti-redeposition | | | | | | | | | | | | |
| agent | | | | | | | | | | | | |
| Thickener | 0.35 | 0.35 | | | | | | | | | | |
| Thinner | | | | 2 | | 2 | | 5 | | 5 | | |

| | |
|---|---|
| PH | 11.5 to 12.0 |

*A preferred nonionic surfactant is BIO-SOFT ® N25-7, Stepan Company. A preferred AES is STEOL ® CS-460, Stepan Company. A preferred FWA is TINOPAL CBS-X, Ciba. A preferred thickener is Cellosize QP 100MH, Dow. Preferred thinners include: C₁₂EO₂, C₁₂EO₃, ethanol, isopropanol, sodium xylene sulfonate, sodium cumene sulfonate, 2-methoxy ethanol, 2-butoxyethanol, methoxy ethoxy ethanol and combinations of these.

The embodiments and examples described here are illustrative, and do not limit the presently described technology in any way. The scope of the present technology described in this specification is the full scope defined or implied by the claims.

What is claimed is:

1. A liquid cleaning composition, comprising:
a. about 1% to about 50% by weight of at least one compound having the following Formula 1: 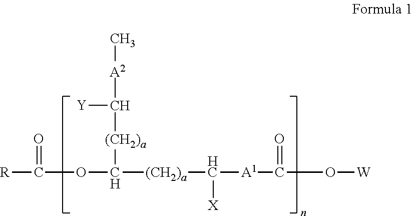
wherein n is an integer from 1-30;
one of X and Y is SO₃—Z, the other of X and Y is H, and X and Y are independently assigned in each repeating unit;
A¹ and A² are linear or branched, saturated or unsaturated, substituted or un-substituted, alkyl diradicals wherein the total number of carbons for each repeating unit is independent and in the range of C₈ to C₂₂;
a is 0, 1, or 2, and is independently assigned in each repeating unit;
R is linear or branched, saturated or unsaturated, substituted or un-substituted, wherein the total number of carbon atoms is from about 1 to about 24;
W is a monovalent cation, divalent metal cation, ammonium cation, substituted ammonium cation, alkyl group, substituted alkyl group or mixture thereof;
Z is a monovalent cation, divalent metal cation, ammonium cation, substituted ammonium cation, or mixture thereof;
b. an effective amount of a cationic polymeric foam builder, the polymeric foam builder comprising monomer units having a cationic charge at a pH of from about 4 to about 12; and
c. about 50% to about 99% water.

2. The composition of claim 1 wherein the polymeric foam builder has an average cationic charge density of about 0.05 to about 5 units per 100 daltons molecular weight at a pH of from about 4 to about 12.

3. The composition of claim 1 wherein the polymeric foam builder is selected from the group consisting of polyquaternium-2, polyquaternium-7 and polyquaternium-10.

4. The composition of claim 1 wherein the foam builder is present in the composition in an amount of about 0.01% to about 10% by weight of the composition.

5. The composition of claim 1 wherein the foam builder is present in the composition in an amount of about 0.05% to about 5% by weight of the composition.

6. The composition of claim 1 wherein the foam builder is present in the composition in an amount of about 0.1% to about 2% by weight of the composition.

7. A liquid laundry detergent composition, comprising:
a. about 1% to about 99% by weight of at least one compound having the following Formula 1: 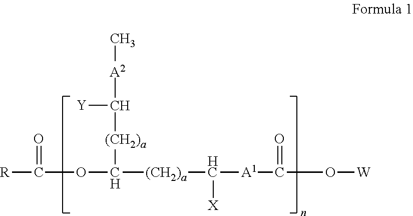
wherein n is an integer from 1-30;
one of X and Y is SO₃—Z, the other of X and Y is H, and X and Y are independently assigned in each repeating unit;
A¹ and A² are linear or branched, saturated or unsaturated, substituted or un-substituted, alkyl diradicals wherein the total number of carbons for each repeating unit is independent and in the range of C₈ to C₂₂;
a is 0, 1, or 2, and is independently assigned in each repeating unit;
R is linear or branched, saturated or unsaturated, substituted or un-substituted, wherein the total number of carbon atoms is from about 1 to about 24;
W is a mono or divalent metal cation, ammonium cation or substituted ammonium cation, or an alkyl or substituted alkyl group;
Z is a mono or divalent metal cation, ammonium or substituted ammonium cation;
b. about 0.01 to about 10% by weight of at least one polymeric foam builder comprising monomer units having a cationic charge at a pH of from about 4 to about 12;
c. 0% to about 40% by weight of at least one additional surfactant; and
d. about 1% to about 99% by weight of water.

8. The composition of claim 7, wherein the composition further comprises 0% to about 40% by weight of at least one additive.

9. The composition of claim 8, wherein the at least one additive is a member selected from the group consisting of at least one builder, at least one alkaline agent, at least one enzyme, at least one chelating agent, at least one polymeric dispersing agent, at least one alkyl polyglucoside, at least one antimicrobial agent, and combinations thereof.

10. The composition of claim 7, wherein the at least one additional surfactant is a member selected from the group consisting of at least one anionic surfactant, at least one nonionic surfactant, at least one cationic surfactant, at least one ampholytic surfactant, at least one zwitterionic surfactant, derivatives thereof, and combinations thereof.

11. The composition of claim 10, wherein the anionic surfactant is alkyl ether sulfate.

12. The composition of claim 7, wherein the formulation exhibits a pH of about 7 to about 12.5.

13. The composition of claim 7, wherein the polymer foam builder has an average cationic charge density of from about 0.05 to about 5 units per 100 Daltons molecular weight at a pH of from about 4 to about 12.

14. The composition of claim 7, wherein the polymeric foam builder is selected from the group consisting of polyquaternium-2, polyquaternium-7 and polyquaternium-10.

15. The composition of claim 7 wherein the foam builder is present in the composition in an amount of about 0.05% to about 5% by weight of the composition.

16. The composition of claim 7 wherein the foam builder is present in the composition in an amount of about 0.1% to about 2% by weight of the composition.
